(19) United States
(12) Patent Application Publication
(10) Pub. No.: US 2023/0422085 A1
(43) Pub. Date: Dec. 28, 2023

(54) MANAGING A WIRELESS LOCAL AREA NETWORK (WLAN) TO SUPPORT A MOBILE COMMUNICATION NETWORK SERVICE

(71) Applicant: QUALCOMM INCORPORATED, San Diego, CA (US)

(72) Inventors: Syam Krishna BABBELLAPATI, Chennai (IN); Xiaolong HUANG, Santee, CA (US); Sitaramanjaneyulu KANAMARLAPUDI, San Diego, CA (US)

(21) Appl. No.: 18/253,590

(22) PCT Filed: May 20, 2021
(86) PCT No.: PCT/US2021/033339

§ 371 Date: May 18, 2023

(30) Foreign Application Priority Data
Jan. 12, 2021 (IN) 202121001315

(51) Int. Cl. H04W 28/02; H04L 1/00

(52) U.S. Cl. CPC H04W 28/0268; H04L 1/0003; H04W 84/12

(57) ABSTRACT

This disclosure provides systems, devices, apparatus and methods, including computer programs encoded on storage media, for managing access in a wireless local area network (WLAN) to support the quality of service (QoS) associated with a service of a wireless communication system. In one aspect, an access device may create a traffic flow between a station (STA) of the WLAN and Na network slice of the wireless communication system. The access device (such as a 5G customer premises equipment (5G-CPE)) may route traffic between the network slice and the STA based on the QoS associated with the network slice. Thus, in some implementations, the QoS for the network slice can be extended into the WLAN.

### CROSS-REFERENCE TO RELATED APPLICATIONS

The present Application is a 371 national stage filing of International PCT Application No. PCT/US2021/033339 by BABBELLAPATI et al. entitled “MANAGING A WIRELESS LOCAL AREA NETWORK (WLAN) TO SUPPORT A MOBILE COMMUNICATION NETWORK SERVICE,” filed May 20, 2021; and claims priority to Indian Patent Application No. 202121001315 by BABBELLAPATI et al. entitled “MANAGING A WIRELESS LOCAL AREA NETWORK (WLAN) TO SUPPORT A MOBILE COMMUNICATION NETWORK SERVICE,” filed Jan. 12, 2021, each of which is assigned to the assignee hereof, and each of which is expressly incorporated by reference in its entirety herein.

### TECHNICAL FIELD

This disclosure generally relates to the field of wireless communication, and more particularly, to quality of service in a wireless local area network.

### DESCRIPTION OF THE RELATED TECHNOLOGY

A wireless local area network (WLAN) may be formed by one or more access points (APs) that provide a shared wireless communication medium for use by a number of client devices also referred to as stations (STAs). The basic building block of a WLAN conforming to the Institute of Electrical and Electronics Engineers (IEEE) 802.11 family of standards is a Basic Service Set (BSS), which is managed by an AP and including one or more wirelessly connected STAs. A station (STA) may have a wireless connection (referred to as a wireless association, or just “association”) when it has authenticated and established a wireless session with the AP. One or more STAs in the WLAN may utilize the shared wireless communication medium to communicate with the AP. The AP may provide access to other network systems such as a wired network or a wireless communication system.

Wireless communication systems are widely deployed to provide various types of communication content such as voice, video, packet data, messaging, broadcast, and so on. These systems may be capable of supporting communication with multiple users by sharing the available system resources (for example, time, frequency, and power). A wireless communication system may include one or more base stations or one or more network access nodes, each simultaneously supporting communication for multiple communication devices, which may be otherwise known as user equipment (UE). Different base stations or network access nodes may implement different radio communication protocols including fourth-generation (4G) systems such as Long Term Evolution (LTE) systems, LTE-Advanced (LTE-A) systems, or LTE-A Pro systems, and fifth-generation (5G) systems which may be referred to as New Radio (NR) systems. NR, which also may be referred to as 5G for brevity, is a set of enhancements to the LTE mobile standard promulgated by the Third Generation Partnership Project (3GPP).

A wireless communication system may support different services. Example services may include voice service, packet data service, enhanced mobile broadband (eMBB), Internet of things (IOT) service, ultra-reliable low latency communication (URLLC), and massive machine type communication (MMTC), among other examples. A UE may be configured to utilize one or more services supported by the wireless communication system. The wireless communication system may use network slicing to support a quality of service (QoS) for a particular service. Network slicing is a network architecture that enables the multiplexing of virtualized and independent logical networks on the same physical network infrastructure. The network slices may be isolated end-to-end networks supporting different features for different applications for the wireless devices. STAs operating in a WLAN managed by an AP may benefit from accessing such network slices in a wireless communication system.

### SUMMARY

The systems, methods and devices of this disclosure each have several innovative aspects, no single one of which is solely responsible for the desirable attributes disclosed herein.

One innovative aspect of the subject matter described in this disclosure can be implemented in a method performed by an access device, such as a customer premises equipment (CPE). The method may include managing at least a first basic service set (BSS) of a wireless local area network (WLAN). The method may include receiving a request for a service of the wireless communication network from a station (STA) associated with the first BSS. The method may include establishing a traffic flow between the STA to a network slice of the wireless communication network. The traffic flow may enable the STA to access the service via the first BSS and the network slice. The method may include managing one or more settings for the first BSS or the traffic flow based, at least in part, on a quality of service (QoS) Indicator (QI) associated with the network slice.

Another innovative aspect of the subject matter described in this disclosure can be implemented in a method performed by a STA. The method may include communicating with a first BSS of a WLAN managed by an access device. The method may include transmitting a request to the access device to establish a traffic flow between the STA to a service of a wireless communication network. The method may include communicating with the service via the first BSS and a network slice of the wireless communication network having a QoS for the service.

Another innovative aspect of the subject matter described in this disclosure can be implemented as an apparatus. The apparatus may include a modem and at least one processor communicatively coupled with the at least one modem. The processor, in conjunction with the modem, may be configured to perform any one of the above-mentioned methods or features described herein.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1A shows a block diagram conceptually illustrating an example wireless local area network (WLAN).

FIG. 1B shows a block diagram conceptually illustrating an example wireless communication system.

FIG. 2 shows a block diagram of an example wireless communication network that includes a 5G-enabled customer premises equipment (5G-CPE).

FIG. 3 illustrates an example of a wireless communication system architecture.

FIG. 4 illustrates an example timing diagram illustrating a process for managing WLAN quality of service (QoS) to support a 5G network slice.

FIG. 5 shows a block diagram of an example 5G-CPE that supports techniques for local area network (LAN) clients participating in a 5G network slice.

FIG. 6 illustrates an example timing diagram illustrating a process in which a 5G-CPE manages a WLAN based on a QoS for a 5G network slice.

FIG. 7 shows a flowchart illustrating an example process for managing a WLAN connection based on quality of service (QoS) for a service of a wireless communication system.

FIG. 8 shows a block diagram of an example wireless communication device that supports techniques for managing a WLAN connection based on a QoS for a network slice.

FIG. 9 shows a block diagram of an example wireless communication device that supports techniques for managing a WLAN connection based on a QoS for a network slice.

FIG. 10 shows a block diagram of an example communications manager that supports techniques for managing a WLAN connection based on a QoS for a network slice.

FIG. 11 shows a block diagram of an example wireless communication system that supports techniques for managing a WLAN connection based on a QoS for a network slice.

FIG. 12 shows a flowchart illustrating an example process performed by an 5G-CPE for enabling access to a service of a wireless communication system.

FIG. 13 shows a flowchart illustrating an example process performed by a STA for utilizing a service of a wireless communication system.

FIG. 14 shows a conceptual diagram of an example message format for communicating regarding a service request and associated QoS parameters.

FIG. 15 shows a block diagram of an example wireless communication device.

Like reference numbers and designations in the various drawings indicate like elements.

### DETAILED DESCRIPTION

The following description is directed to certain implementations for the purposes of describing innovative aspects of this disclosure. However, a person having ordinary skill in the art will readily recognize that the teachings herein can be applied in a multitude of different ways. The described implementations can be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G standards, among others. The described implementations can be implemented in any device, system or network that is capable of transmitting and receiving RF signals according to one or more of the following technologies or techniques: code division multiple access (CDMA), time division multiple access (TDMA), frequency division multiple access (FDMA), orthogonal frequency division multiple access (OFDMA), single-user (SU) multiple-input-multiple-output (MIMO) and multi-user (MU) MIMO. The described implementations also can be implemented using other wireless communication protocols or RF signals suitable for use in one or more of a wireless personal area network (WPAN), a wireless local area network (WLAN), a wireless wide area network (WWAN), or an internet of things (IoT) network.

Various implementations of this disclosure relate generally to the use of wireless resources in a WLAN to access a service provided by a wireless communication system. An access point (AP) of a WLAN may manage a Basic Service Set (BSS) that provides network access for one or more wirelessly connected stations (STAs). A STA may have a wireless connection (referred to as a wireless association, or just “association”) when it has authenticated and established a wireless session with the AP. In some implementations, the AP may be collocated or integrated with an access device having capabilities to access one or more wireless communication systems, such as a fifth generation (5G) wireless communication system. In some implementations, the access device also may be referred to customer premises equipment (CPE), a fixed wireless access (FWA) device, or a 5G-CPE, among other examples. In this disclosure, the terms 5G-CPE and access device may be used interchangeably. In one aspect, the 5G-CPE may receive a request via a WLAN from one or more STAs to access a service of the 5G wireless communication system. The 5G-CPE may enable a STA in the WLAN to utilize a particular service provided by the 5G wireless communication system. In some implementations, the AP may influence a BSS configuration of the WLAN, manage a distribution of resources in the WLAN, or modify other WLAN parameters to support a quality of service (QoS) associated with the requested service of the 5G wireless communication system. In some implementations, the 5G-CPE may manage scheduling of uplink (UL) or downlink (DL) resources in the WLAN so that the STA can achieve a QoS in the WLAN that corresponds to a QoS requirement of the requested service in the 5G wireless communication system.

A 5G wireless communication system may support various services. Example services may include voice service, packet data service, enhanced mobile broadband (eMBB), Internet of things (IOT) service, ultra-reliable low-latency communication (URLLC), and massive machine type communication (MMTC), among other examples. Each service may be associated with a different set of QoS requirements. Third Generation Partnership Project (3GPP) standards development organization (SDO) has defined a plurality of QoS Indicators (QIs) to refer to one or more QoS requirements for an end-to-end QoS in a wireless communication system. In the 5G ecosystem, a QI may be referred to as a 5G QI or a 5QI. For brevity, some examples in this disclosure refer to QI and 5QI interchangeably. When a service is invoked in the 5G wireless communication system, the service may be associated with a particular 5QI value. For example, the URLLC service may be associated with a 5QI value (such as 5QI of 80 or greater) that requires a guaranteed bit rate (GBR) or a delay critical GBR. Other services may be associated with different 5QI values. The 5G wireless communication system may use network slicing to support a particular 5QI needed for a particular service. Network slicing is a network architecture that enables the multiplexing of virtualized and independent logical networks on the same physical network infrastructure. A 5G wireless communication system may create a network slice for each user equipment (UE) access the service via the 5G wireless communication. Furthermore, the 5G wireless communication system may assign a corresponding 5QI value that defines the QoS for that network slice.

As described herein, a 5G-CPE may enable bridging or routing of traffic between a STA in a WLAN to a service in the 5G wireless communication system. For example, a UE may incorporate or include a STA configured to operate in a WLAN. The UE may be capable of accessing the service of the 5G wireless communication system by connecting the STA to a WLAN managed by the 5G-CPE. The 5G-CPE may concurrently connect to a radio access network (RAN) of the 5G wireless communication system. The 5G-CPE can establish a network slice for the service via the 5G wireless communication system and determine the 5QI value associated with the service. However, absent the techniques of this disclosure, the end-to-end QoS for the 5QI may not account for QoS of the WLAN communications between the 5G-CPE and the STA. For example, a traditional 5G-CPE may manage a 5G wireless connection based on the 5QI but the QoS may be lost when traffic is sent or received via the WLAN. Using the techniques of this disclosure, the 5G-CPE can manage QoS of the WLAN such that the QoS parameters of the 5QI value can be extended to include the WLAN communication between the STA and the 5G-CPE. In some implementations, the 5G-CPE may manage how the STA communicates with the 5G-CPE and manage scheduling of the UL/DL transmissions in the WLAN based on the 5QI value associated with a particular network slice.

In accordance with this disclosure, the 5G-CPE may manage one or more WLAN settings to support a 5QI needed for a network slice to a particular service. For example, 5G-CPE (acting as an AP of the WLAN) may manage one or more BSS configurations to reduce variable latency on the WLAN medium. The 5G-CPE may determine the 5QI needed for the service and manipulate or manage the operation of the WLAN such that the STA can achieve a corresponding QoS on the WLAN. For example, the 5G-CPE may create a prioritized queue for the traffic flow based on the 5QI. The 5G-CPE may require the STA to connect to the AP using a particular wireless channel or frequency band (such as 6 GHz frequency band). In another example, the 5G-CPE may entertain access to the network slice if the STA is connected using MIMO or OFDMA when the network slice is associated with particular 5QI. The 5G-CPE may set a modulation and coding scheme (MCS) parameter for the STA to support the 5QI of the network slice. In some implementations, the 5G-CPE may manage contention-based access settings for the BSS to give higher priority to a STA that has uplink traffic for a particular service. Any combination of the above techniques may be applied depending on the QI associated with the service.

Some examples of this disclosure are based on a STA utilizing an 5G-CPE to communicate with a URLLC service of the wireless communication network. For each STA accessing the URLLC service, the 5G-CPE may establish a separate traffic flow mapped to a separate 5G bearer channel to facilitate priority handling of traffic for the URLLC via the WLAN and the 5G communication system. The 5G-CPE may determine the 5QI associated with the URLLC service and implement one or more additional techniques to prioritize access between the STA and the URLLC service. For example, the 5G-CPE may require the STA to utilize the 6 GHz frequency band which has less channel contention. Furthermore, the 6 GHz frequency band may be utilized by WLAN devices that implement High Efficiency (HE) defined in IEEE 802.11ax, Extremely High Throughput (EHT) defined in IEEE 802.11be, or other such WLAN-based future standards. The 6 GHz frequency band is not utilized by WLAN devices that implement legacy versions of IEEE 802.11 (such as 802.11a, 802.11b, 802.11g, 802.11n, or 802.11ac). In some implementations, the 5G-CPE may require the STA to utilize MIMO with a minimum quantity of spatial streams. Doing so may increase reliability for the URLLC traffic flow. In some implementations, the 5G-CPE may choose a lower MCS option (such as MCS8 or lower) to increase reliability of the WLAN transmissions for the URLLC traffic flow even if the STA and the 5G-CPE are capable of a higher MCS.

To manage uplink access via the WLAN, the 5G-CPE may suppress single user (SU) transmissions and require STAs on that wireless channel to utilize multi-user (MU) enhanced distributed control access (MU EDCA). For example, the 5G-CPE may set contention parameters to favor STAs that have URLLC traffic flows. The contention parameters may include a minimum contention window (CWmin), a maximum contention window (CWmax), an arbitration interframe space number (AIFSN), or a maximum transmission opportunity, among other examples. In some implementations, the 5G-CPE may schedule additional uplink resources for a STA that has an URLLC traffic flow. For example, the 5G-CPE may schedule uplink resources for the STA that sends a buffer status report (BSR) indicating a low amount of buffered traffic. Traditionally, an AP would require a sufficient qdepth (indicating amount of buffered traffic) before scheduling uplink resources for a STA. However, in accordance with some implementations of this disclosure, the 5G-CPE may give priority to a STA that has a URLLC traffic flow even when the qdepth is below a traditional threshold. In some implementations, the 5G-CPE may schedule uplink resources with a regularity or volume that is based on the 5QI needed for the URLLC service.

The 5G-CPE may allocate uplink and downlink resources to satisfy the 5QI of the service. In some implementations, a WLAN may use contention-based access. Contention-based access may be referred to as unscheduled access because a STA would contend for access rather than having resources allocated or scheduled for it. However, even for contention-based uplink access, the selection of different contention parameters (associated with various access categories) may enable a STA to have a higher priority to gain access to the channel. In some implementations, the access node may attempt to satisfy a 5QI of the service by selecting an appropriate access mode. For example, the 5G-CPE may allocate or scheduled uplink resources for the STA based on the 5QI of the service. In some implementations, the 5G-CPE may use OFDMA to schedule UL resources for the STA, may require a minimum quantity of spatial streams for UL MU-MIMO, or both, to enforce QoS on the WLAN based on the 5QI of the service.

In a scheduled WLAN, the 5G-CPE may increase the resources (such as bandwidth, number of spatial streams, resource unit size, modulation and coding scheme, among other examples) allocated to the STA based on the 5QI of the service, or may increase the quantity or timing of allocated resources for the STA. The 5G-CPE may determine that the scheduled access mode may not satisfy the 5QI. Therefore, in some cases, the 5G-CPE may permit the STA to use a contention-based uplink access mode with higher priority than other STAs. For example, the 5G-CPE may designate a higher priority (or other contention parameters) to the STA such that the STA has a greater likelihood of winning the contention for the channel. Using EDCA, a set of parameters (referred to as contention parameters) may be associated with a particular access category (AC) and level of priority. Different access categories (having different levels of priority) may have different contention parameters that impact the likelihood that a STA will win contention for the channel. Examples of contention parameters include contention window boundaries (CWmin, CWmax), arbitration interframe space (AIFS), TXOP limit, and backoff algorithm. In some implementations, the 5G-CPE may adjust or select the contention parameters for a STA to satisfy the 5QI of the service.

Particular implementations of the subject matter described in this disclosure can be implemented to realize one or more of the following potential advantages. In some implementations, the described techniques can be used to enable STAs supported by a 5G-CPE to request and utilize one or more network slices that are extended into the WLAN domain. In some implementations, the techniques and other aspects described in this disclosure may enable one or more STAs to access a URLLC service via a WLAN.

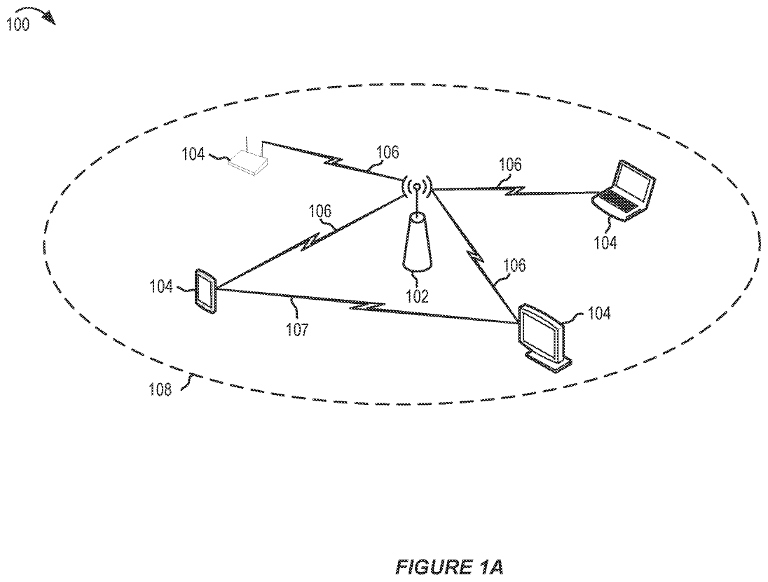

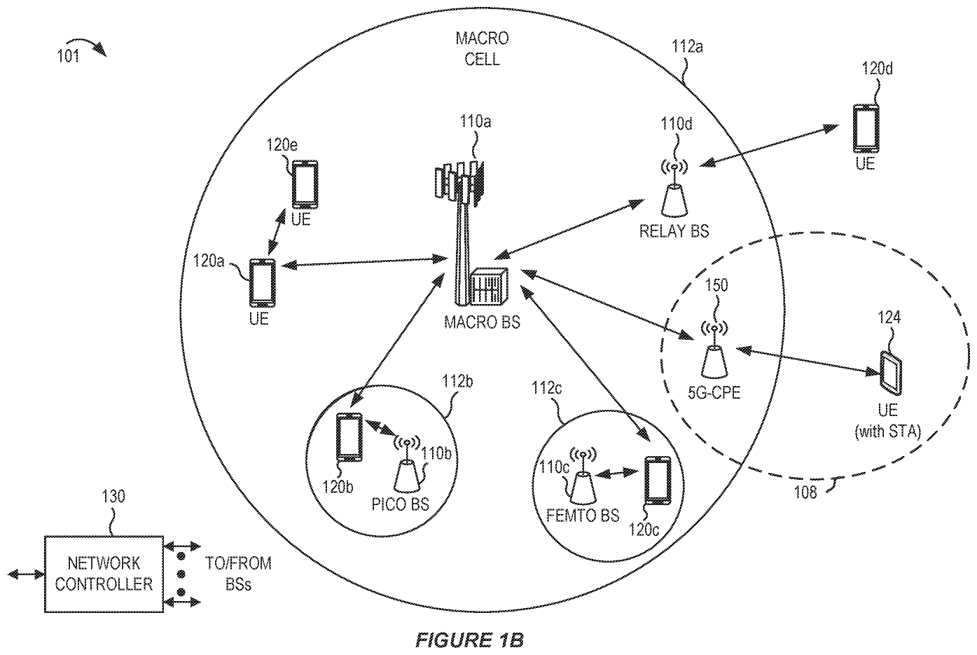

FIG. 1A shows a block diagram conceptually illustrating an example WLAN 100. According to some aspects, the WLAN 100 can be a network implementing at least one of the IEEE 802.11 family of wireless communication protocol standards (such as that defined by the IEEE 802.11-2016 specification or amendments thereof including, but not limited to, 802.11ay, 802.11ax, 802.11az, 802.11ba and 802.11be). The WLAN 100 may include numerous wireless communication devices such as an AP 102 and multiple STAs 104. While only one AP 102 is shown, the WLAN 100 also can include multiple APs 102.

Each of the STAs 104 also may be referred to as a LAN client, a mobile station (MS), a mobile device, a mobile handset, a wireless handset, an access terminal (AT), a user equipment (UE), a subscriber station (SS), or a subscriber unit, among other possibilities. In some implementations a STA 104 may be incorporated or integrated in a UE that also has a 5G modem (not shown). The STAs 104 may represent various devices such as mobile phones, personal digital assistant (PDAs), other handheld devices, netbooks, notebook computers, tablet computers, laptops, display devices (for example, TVs, computer monitors, navigation systems, among others), music or other audio or stereo devices, remote control devices (“remotes”), printers, kitchen or other household appliances, key fobs (for example, for passive keyless entry and start (PKES) systems), among other possibilities. While AP 102 is described as an access point using an infrastructure mode, in some implementations, the AP 102 may be a STA which is operating as an AP. For example, the AP 102 may be a STA capable of operating in a peer-to-peer mode or independent mode. In other examples, the AP 102 may be a software AP (SoftAP) operating on a computer system.

A single AP 102 and the associated STAs 104 may be referred to as a basic service set (BSS), which is managed by the respective AP. An “unassociated STA” may not be considered part of the BSS because they do not have a wireless session established with the first AP 102. The BSS is identified by a service set identifier (SSID) that is advertised by the AP 102. The AP 102 periodically broadcasts beacon frames (“beacons”) to enable any STAs within wireless range of the AP 102 to establish or maintain a respective communication link 106 (hereinafter also referred to as a “Wi-Fi link” or “wireless association”) with the first AP 102. The various STAs in the WLAN are able to communicate with external networks as well as with one another via the AP 102 and respective communication links 106.

To establish a communication link 106 with an AP 102, each of the STAs is configured to perform passive or active scanning operations (“scans”) on frequency channels in one or more frequency bands (for example, the 2.4 GHz, 5 GHz, 6 GHz or 60 GHz bands). To perform passive scanning, a STA listens for beacons, which are transmitted by respective APs 102 at a periodic time interval referred to as the target beacon transmission time (TBTT) (measured in time units (TUs) where one TU is equal to 1024 microseconds (s)). To perform active scanning, a STA 104 generates and sequentially transmits probe requests on each channel to be scanned and listens for probe responses from APs 102. Each STA 104 may be configured to identify or select an AP 102 with which to associate based on the scanning information obtained through the passive or active scans, and to perform authentication and association operations to establish a Wi-Fi link with the selected first AP 102. The AP 102 may assign an association identifier (AID) to the STA 104 at the culmination of the association operations, which the AP 102 uses to track the STA 104.

FIG. 1 additionally shows an example coverage area 108 of the AP 102, which may represent a basic service area (BSA) of the WLAN 100. As a result of the increasing ubiquity of wireless networks, a STA 104 may have the opportunity to select one of many BSSs within range of the STA or to select among multiple APs 102 that together form an extended service set (ESS) including multiple connected BSSs. An extended network station associated with the WLAN 100 may be connected to a wired or wireless distribution system that may allow multiple APs 102 to be connected in such an ESS. As such, a STA 104 can be covered by more than one AP 102 and can associate with different APs 102 at different times for different transmissions. Additionally, after association with an AP 102, a STA 104 also may be configured to periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. Some examples of such a network is an ad hoc network (or wireless ad hoc network). Ad hoc networks may alternatively be referred to as mesh networks or peer-to-peer (P2P) networks. In some examples, ad hoc networks may be implemented within a larger wireless network such as the WLAN 100. In such implementations, while the STAs 104 may be capable of communicating with each other through the AP 102 using communication links 106, STAs 104 also can communicate directly with each other via direct wireless links 107. Additionally, two STAs 104 may communicate via a direct wireless link 107 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless links 107 include Wi-Fi Direct connections, connections established by using a Wi-Fi Tunneled Direct Link Setup (TDLS) link, and other P2P group connections.

The APs 102 and STAs 104 may function and communicate (via the respective communication links 106) according to the IEEE 802.11 family of wireless communication protocol standards (such as that defined by the IEEE 802.11-2016 specification or amendments thereof including, but not limited to, 802.11ay, 802.11ax, 802.11az, 802.11ba and 802.11be). These standards define the WLAN radio and baseband protocols for the PHY and medium access control (MAC) layers. The APs 102 and STAs 104 transmit and receive wireless communications (hereinafter also referred to as “Wi-Fi communications”) to and from one another in the form of PHY protocol data units (PPDUs) (or physical layer convergence protocol (PLCP) PDUs). The APs 102 and STAs 104 in the WLAN 100 may transmit PPDUs over an unlicensed spectrum, which may be a portion of spectrum that includes frequency bands traditionally used by Wi-Fi technology, such as the 2.4 GHz band, the 5 GHz band, the 60 GHz band, the 3.6 GHz band, and the 900 MHz band. Some implementations of the APs 102 and STAs 104 described herein also may communicate in other frequency bands, such as the 6 GHz band, which may support both licensed and unlicensed communications. The APs 102 and STAs 104 also can be configured to communicate over other frequency bands such as shared licensed frequency bands, where multiple operators may have a license to operate in the same or overlapping frequency band or bands.

Each of the frequency bands may include multiple sub-bands or frequency channels. For example, PPDUs conforming to the IEEE 802.11n, 802.11ac, 802.11ax and 802.11be standard amendments may be transmitted over the 2.4, 5 GHz or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 or 320 MHz by bonding together multiple 20 MHz channels.

Each PPDU is a composite structure that includes a PHY preamble and a payload in the form of a PHY service data unit (PSDU). The information provided in the preamble may be used by a receiving device to decode the subsequent data in the PSDU. In instances in which PPDUs are transmitted over a bonded channel, the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is based on the particular IEEE 802.11 protocol to be used to transmit the payload.

As described above, the APs 102 and the STAs 104 can support multi-user (MU) communications; that is, concurrent transmissions from one device to each of multiple devices (for example, multiple simultaneous downlink (DL) communications from an AP 102 to corresponding STAs 104), or concurrent transmissions from multiple devices to a single device (for example, multiple simultaneous uplink (UL) transmissions from corresponding STAs 104 to an AP 102). To support the MU transmissions, the APs 102 and STAs 104 may utilize multi-user multiple-input, multiple-output (MU-MIMO) and multi-user orthogonal frequency division multiple access (MU-OFDMA) techniques.

In traditional WLAN deployments, the SU access mode was based on contention-based access in which a station obtains the use of the full channel in the form of a transmit opportunity (TxOP) when it wins contention. Different priorities and access categories may be used by the WLAN to implement the prioritization of traffic. More recently, the IEEE draft 802.11ax technical standard implemented OFDMA which supports more efficient use of a wireless channel using either a scheduled access mode or a contention-based access mode. In the scheduled access mode, the first AP 102 may allocate portions of an UL MU PPDU to different stations. In the contention-based access mode, the first AP 102 may trigger contention-based access for portions of a transmission opportunity by various STAs. In either access mode, the first AP 102 may control or manipulate the BSS to give priority to one or more STAs 104.

The scheduled access mode enables the first AP 102 to control the allocation and scheduling of uplink resources. The first AP 102 may send a trigger message (such as a “Basic Trigger frame”) to one or more STAs to cause the STAs to send their uplink data in response to the trigger message. The first AP 102 may determine a schedule for the uplink data based on feedback from the STAs (such as feedback in response to a Beamforming Report poll (BRP) trigger, Buffer Status Report Poll (BSRP) Trigger, MU-BAR trigger, NDP Feedback report poll (NFRP) trigger, or Bandwidth query report poll (BQRP), among other examples). The feedback from the STAs may indicate an amount of data available for uplink transmission from the STA. Additionally, a STA may send a buffer status report (BSR) to indicate uplink buffered data.

In traditional deployments of a fully scheduled WLAN, the first AP 102 may send trigger messages to trigger a particular STA with regularity. The first AP 102 may determine which STAs to trigger with each trigger message. In this disclosure, the AP 102 may be collocated or integrated with a 5G-CPE having capabilities to access a 5G wireless communication system. The 5G wireless communication system may define the 5QI for various services. The AP 102 may manage the periodicity of trigger messages to a STA 104 based on a 5QI associated with a service of a 5G wireless communication system. For example, the AP 102 may cause trigger messages to periodically trigger the STA 104 so that the STA 104 can transmit uplink data within a latency requirement. The periodicity of the trigger messages may be determined based on the 5QI value assigned to a network slice for the service. For context, an example 5G wireless communication system that includes a 5G-CPE is described with reference to FIG. 1B.

FIG. 1B shows a block diagram conceptually illustrating an example of a wireless communication system 101. A wireless communication system (which also may be referred to as a wireless communication network) may include one or more radio access networks (RANs). A radio access network (RAN, sometimes also referred to as a radio network, or access network) may include a number of base stations (B Ss) that can support communication for a number of user equipment (UEs). Different types of base stations may be referred to as a NodeB, an LTE evolved NodeB (eNB), a next generation NodeB (gNB), an access point (AP), a radio head, a transmit-receive point (TRP), among other examples, depending on the wireless communication standard that the base station supports. One or more gNBs may make up a 5G New Radio (NR) RAN, and may provide access to the 5G wireless communication system.

The wireless communication system 101 described with reference to FIG. 1B may include a 5G NR RAN or some other RAN, such as an LTE RAN. The wireless communication system 101 may include a number of BSs 110 (shown as BS 110a, BS 110b, BS 110c, and relay station 110d) and other network entities. ABS is an entity that communicates with user equipment (UEs) and also may be referred to as a base station, a NR BS, a Node B, a gNB, a 5G node B (NB), an access point, a transmit receive point (TRP), or the like. Each BS may provide communication coverage for a particular geographic area. In 3GPP, the term “cell” can refer to a coverage area of a BS, a BS subsystem serving this coverage area, or a combination thereof, depending on the context in which the term is used. A UE may communicate with a base station via the downlink (DL) and uplink (UL). The DL (or forward link) refers to the communication link from the BS to the UE, and the UL (or reverse link) refers to the communication link from the UE to the BS.

A BS may provide communication coverage for a macro cell, a pico cell, a femto cell, another type of cell, or a combination thereof. A macro cell may cover a relatively large geographic area (for example, several kilometers in radius) and may allow unrestricted access by UEs with service subscription. A pico cell may cover a relatively small geographic area and may allow unrestricted access by UEs with service subscription. A femto cell may cover a relatively small geographic area (for example, a home) and may allow restricted access by UEs having association with the femto cell (for example, UEs in a closed subscriber group (CSG)). A BS for a macro cell may be referred to as a macro BS. ABS for a pico cell may be referred to as a pico BS. A BS for a femto cell may be referred to as a femto BS or a home BS. In the example shown in FIG. 1B, a BS 110a may be a macro BS for a macro cell 112a, a BS 110b may be a pico BS for a pico cell 112b, and a BS 110c may be a femto BS for a femto cell 112c. ABS may support one or multiple (for example, three) cells. The terms “eNB,” “base station,” “NR BS,” “gNB,” “TRP,” “AP,” “node B,” “5G NB,” and “cell” may be used interchangeably herein.

In some examples, a cell may not necessarily be stationary, and the geographic area of the cell may move according to the location of a mobile BS. In some examples, the BSs may be interconnected to one another as well as to one or more other BSs or network nodes (not shown) in the wireless communication system 101 through various types of backhaul interfaces, such as a direct physical connection, a virtual network, or a combination thereof using any suitable transport network.

The wireless communication system 101 also may include relay stations. A relay station is an entity that can receive a transmission of data from an upstream station (for example, a BS or a UE) and send a transmission of the data to a downstream station (for example, a UE or a BS). A relay station also may be a UE that can relay transmissions for other UEs. In the example shown in FIG. 1B, a relay station 110d may communicate with macro BS 110a and a UE 120d in order to facilitate communication between BS 110a and UE 120d. A relay station also may be referred to as a relay BS, a relay base station, or a relay, among other examples.

The wireless communication system 101 may include a heterogeneous network that includes BSs of different types, for example, macro BSs, pico BSs, femto BSs, relay BSs, among other examples. These different types of B Ss may have different transmit power levels, different coverage areas, and different impacts on interference in wireless communication system 101. For example, macro BSs may have a high transmit power level (for example, 5 to 40 Watts) whereas pico BSs, femto BSs, and relay BSs may have lower transmit power levels (for example, 0.1 to 2 Watts).

A network controller 130 may couple to a set of BSs and may provide coordination and control for these BSs. The network controller 130 may communicate with the BSs via a backhaul. The BSs also may communicate with one another, for example, directly or indirectly via a wireless or wireline backhaul.

UEs 120 (for example, 120a, 120b, 120c) may be dispersed throughout wireless communication system 101, and each UE may be stationary or mobile. A UE also may be referred to as an access terminal, a terminal, a mobile station, a subscriber unit, or a station, among other examples. A UE may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (for example, smart ring, smart bracelet)), an entertainment device (for example, a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, location tags, among other examples, that may communicate with a base station, another device (for example, remote device), or some other entity. A wireless node may provide, for example, connectivity for or to a network (for example, a wide area network such as Internet or a cellular network) via a wired or wireless communication link. Some UEs may be considered Internet-of-Things (IoT) devices or may be implemented as NB-IoT (narrowband internet of things) devices. Some UEs may be considered a Customer Premises Equipment (CPE). UE 120 may be included inside a housing that houses components of UE 120, such as processor components, memory components, similar components, or a combination thereof.

In general, any number of RANs may be deployed in a given geographic area. Each RAN may support a particular RAT and may operate on one or more frequencies. A RAT also may be referred to as a radio technology, an air interface, among other examples. A frequency also may be referred to as a carrier, a frequency channel, among other examples. Each frequency may support a single RAT in a given geographic area in order to avoid interference between RANs of different RATs. In some cases, NR or 5G RANs may be deployed.

In some examples, access to the air interface may be scheduled, where a scheduling entity (for example, a base station) allocates resources for communication among some or all devices and equipment within the scheduling entity's service area or cell. Within the present disclosure, as discussed further below, the scheduling entity may be responsible for scheduling, assigning, reconfiguring, and releasing resources for one or more subordinate entities. That is, for scheduled communication, subordinate entities utilize resources allocated by the scheduling entity.

Base stations are not the only entities that may function as a scheduling entity. That is, in some examples, a UE or 5G-CPE may function as a scheduling entity, scheduling resources for one or more subordinate entities (for example, one or more other UEs). In this example, the is functioning as a scheduling entity, and other UEs utilize resources scheduled by the for wireless communication.

A UE may function as a scheduling entity in a peer-to-peer (P2P) network, in a mesh network, or another type of network. In a mesh network example, UEs may optionally communicate directly with one another in addition to communicating with the scheduling entity. In some aspects, two or more UEs 120 (for example, shown as UE 120a and UE 120e) may communicate directly using one or more sidelink channels (for example, without using a base station 110 as an intermediary to communicate with one another). For example, the UEs 120 may communicate using peer-to-peer (P2P) communications, device-to-device (D2D) communications, a vehicle-to-everything (V2X) protocol (which may include a vehicle-to-vehicle (V2V) protocol, a vehicle-to-infrastructure (V2I) protocol, or similar protocol), a mesh network, or similar networks, or combinations thereof. In this case, the UE 120 may perform scheduling operations, resource selection operations, as well as other operations described elsewhere herein as being performed by the base station 110.

As described herein, a 5G-CPE 150 may operate as an AP providing a WLAN coverage area 108 and WLAN service to a UE 124 that also includes a STA. For example, the UE 124 may have a 5G modem (not shown) capable of connecting to a base station 110 of the NR RAN. The UE 124 also may have a STA capable of connecting to a WLAN managed by the 5G-CPE 150. The 5G-CPE 150 may connect to a base station 110 of the 5G NR RAN. The 150 may bridge or route traffic between the UE 124 (STA) and the base station 110.

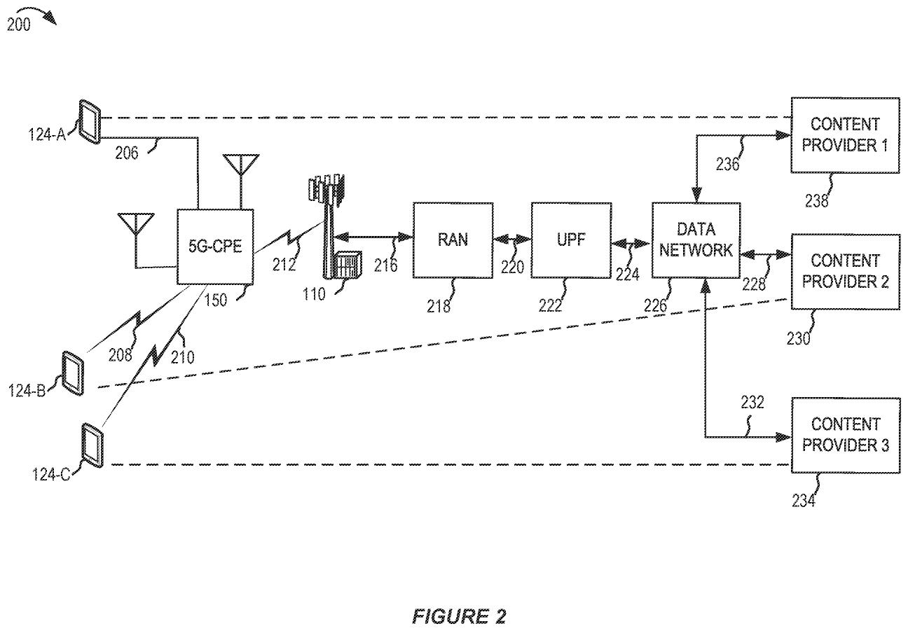

In some implementations, the 5G-CPE 150 can manage the BSS of the WLAN to support the QoS associated with a network slice created in a 5G wireless communication system. For example, the wireless communication system 101 (or the wireless communication network 200 described with reference to FIG. 2) may support the creation of different network slices for particular UEs, such as UE 120 and UE 124 to access a service of the 5G wireless communication system.

FIG. 2 shows a block diagram of an example wireless communication network 200 that includes a 5G-CPE 150. The wireless communications network 200 combine some aspects of the WLAN 100 and the wireless communication system 101 described with reference to FIGS. 1A and 1B, respectively. The wireless communication network 200 may include a 5G-CPE 150 (such as a 5G-CPE including a WLAN AP and a 5G modem) and UEs 124-a, 124-b, and 124-c (which also may be examples of UE 124 described with reference to FIG. 1B). The 150 may provide network coverage for a wireless local area network. The 5G-CPE 150 and the UEs 124-a, 124-b, and 124-c may communicate over one or more communication links. For example, the 5G-CPE 150 and the UE 124-a may communicate over a wired communication link 206 (such as Ethernet), the 5G-CPE 150 and the UE 124-b may communicate over a wireless communication link 208 (such as a WLAN according to IEEE 802.11), and the 5G-CPE 150 and the UE 124-c may communicate over a wireless communication link 210 (such as a WLAN communication link or a 5G communication link). The UEs 124-a, 124-b, and 124-c in conjunction with the 5G-CPE 150 may utilize one or more network slices to improve communication efficiency and to obtain a power advantage for communications, among other advantages.

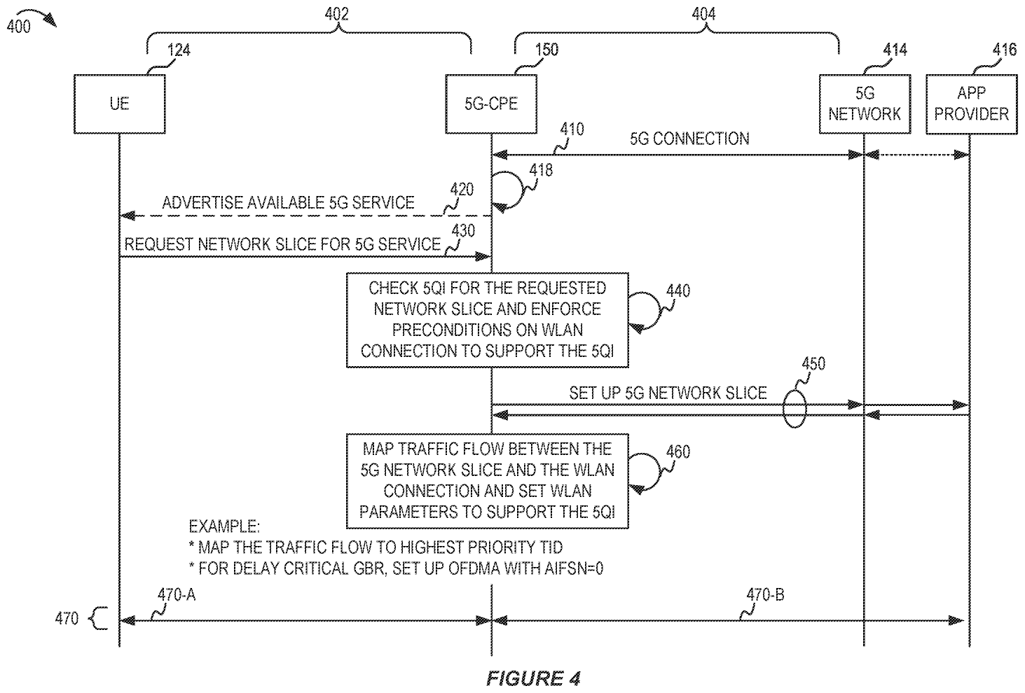

In some examples, the 5G-CPE 150 may communicate with a base station 110 using a wireless communication link 212. The base station 110 may be a base station providing or accessing a 5G or NR network. The base station 110 may communicate with a radio access network (RAN) 218 using a wired or wireless communication link 216. As shown with reference to FIG. 2, the RAN 218 may communicate with a user plane function (UPF) 222 using communication link 220. The UPF 222 may communicate with a data network 226 using communication link 224. In some implementations, the data network 226 may be configured to access multiple content providers (or application providers). The data network 226 may communicate with a first content provider (Content Provider 1) using communication link 236. Additionally, or alternatively, the data network 226 may communicate with a second content provider (Content Provider 2) using communication link 228, and may communicate with a third content provider (Content Provider 2) using communication link 232. The wireless communication network 200 is configured to perform one or more of the processes illustrated in timing diagrams 400 and 600, or any of the processes 1200, and 1300 described above with reference to FIGS. 4, 6, 12, and 13, respectively.

According to some implementations, the wireless communication network 200 may support network slicing. A network slice may include a set of network functions and resources so that it can operate as a complete logical network within a wireless communication system. For example, a base station may be logically partitioned so that a first logical portion of the base station belongs to a first network slice and a second logical portion of the base station belongs to a second network slice. Each network slice may include a service layer, a network function layer, and a logical network layer (sometimes also referred to as an infrastructure layer or resource layer). Despite being partitioned into network slices, some portions of the network slices may be implemented in the same hardware components. By defining network slices, a wireless communication system can designate different quality of service or configurations for each service. For example, each network slice can have its own architecture, management, and security to support a specific service. While functional components and resources may be shared across network slices, capabilities such as data speed, capacity, connectivity, quality, latency, reliability, and services can be customized in each slice to conform to the service. Each network slice may be identified by a single network slice selection assistance information (S-NSSAI) identifier. The S-NSSAI includes a slice/service type (SST) value and optionally includes a slice differentiator (SD) value. The SST may refer to the expected network slice behavior in terms of features and services, and the SD may be optional information that complements the SST to differentiate amongst multiple network slices of the same SST.

In some examples, wireless communication network (such as the wireless communication network 200) may support 5G technology. The 5G communication network may be configured to offer different services to applications based on network slices. In some implementations, a network slice can be described as an end-to-end tunnel between an application hosted on a UE (such as UEs 124-a, 124-b, and 124-c) and the application-provider. The network slicing may be supported by the 5G core network and the RAN (such as the base station 110 in conjunction with the RAN 218).

Some example network slicing types may be categorized according to Table 1.

TABLE 1

| Slice/Service | SST | |
|---|---|---|
| type | value | Characteristics |
| eMBB | 1 | Network slice suitable for the handling of 5G |
| | | enhanced Mobile Broadband. |
| URLLC | 2 | Network slice suitable for the handling of ultra- |
| | | reliable low latency communications. |
| MioT | 3 | Network slice suitable for the handling of massive |
| | | IoT. |

Each network slice type or service type may be associated with different quality of service (QoS) requirements or parameters including latency and performance parameters. In some examples, a URLLC service may be provisioned for a latency of 1 millisecond (ms) on the air interface (0.5 ms in each direction). Thus, for the URLLC service type, the network slice provides for a user plane latency value of 0.5 ms for uplink communications and 0.5 ms for downlink communications. Furthermore, for the URLLC service type, the latency value may support the use of the next generation access technologies as a wireless transport technology that can be used within the next generation access architecture. In some examples, a reliability key performance indicator may provide a latency value with an associated reliability parameter. In some examples, the latency value may be an average value that does not have an associated high reliability parameter. In some examples, for the eMBB service type, a network slice provides for a user plane latency value of 4 ms for uplink communications and 4 ms for downlink communications. In some examples, a latency value for the eMBB service type may be based on all typical delays associated with the transfer of data packets (for example, an applicable procedural delay when resources are not pre-allocated, an average hybrid automatic repeat request retransmission delay, and delays associated with the network architecture). In some implementations, for the URLLC service type, the QoS parameter associated with the latency may have a higher threshold (0.5 ms for uplink communications and 0.5 ms for downlink communications). To support the URLLC service type, a conventional wireless communication network may support the higher threshold for the QoS parameter associated with the latency between the 5G core network (such as the RAN) and the UE.

The 5G wireless communication system may define 5QI values associated with a set of QoS parameters and requirements. For example, a 5QI value of “1” may define a GBR having a default priority level of “20,” a packet delay budget of 100 ms, a packet error rate no greater than 10′, and a default averaging window of 2000 ms. The 5QI value of “1” may be suitable for conversational voice service. Other 5QI values may be associated with different sets of QoS parameters suitable for various services. A network slice that is created for an URLLC service may have a 5QI value that includes more stringent QoS parameters. As an example, a 5QI value of 80 or greater may have QoS parameters that support end-to-end latency that includes air interface round-trip latency as well as the latency through other components of the network slice. URLLC may be associated with a 5QI value that has a Delay Critical GBR (such as 5QI value>=80). Thus, the 5QI value>=80 also may satisfy the 1 ms round trip latency of the air interface.

In addition to the network slice type or service type, one or more operators can define a slice type or service type with the characteristics associated with the operators. Specifically, existing wireless communication networks allow for customized network slices to be created and serviced using different 5QI parameters. Additionally, or alternatively, existing wireless communication networks that support network slicing may account for end-to-end latencies. In some examples, end-to-end latencies may include the application latencies on a UE. In some examples, the application latencies for different applications may be 3-5 ms for the URLLC service type. In some implementations, it may be important to account for application latency as part of an overall end-to-end latency (for example, an end-to-end latency between an application and a 5G core network). In an example of a live audio performance that may be associated with an application and a 5G core network, there may exist a deterministic latency to receive the live audio over a wireless communication network and an application latency associated with processing a live audio at a UE.

As shown with reference to FIG. 2, the UEs 124-a, 124-b, and 124-c may host different applications. For example, an application hosted in the UE 124-a may be associated with the content provider 238 (Content Provider 1). Likewise, an application hosted in the UE 124-b may be associated with the content provider 230 (Content Provider 2) and an application hosted in the UE 124-c may be associated with the content provider 234 (Content Provider 3). According to some implementations, the UEs 124-a, 124-b, and 124-c may utilize different network slices to access different client applications. In some examples, the wireless communication network 200 supports signaling between the 5G-CPE 150 and the LAN clients (for example, the UEs 124-a, 124-b, and 124-c) to enable the use of network slices by the LAN clients. With the framework described with reference to FIG. 2, the LAN clients may benefit from requesting and accessing network slices from a 5G core network.

In one or more implementations, the wireless communication network 200 may enable the use of network slices by LAN clients (such as UEs 124-a, 124-b, and 124-c). Specifically, the 5G-CPE 150 may handle a network slice request from one or more of the LAN clients. In some aspects, the wireless communication network 200 may handle the access and creation of network slices in two scenarios. In an example of a first scenario, the LAN clients (for example, UE 124-a) and their applications may be unaware of the available network slices. In such an example, the 5G-CPE 150 may handle an initiation of a network slice without one or more of the LAN clients being aware of a slice initiation. In an example of a second scenario, the LAN clients (for example, UEs 124-b and 124-c) and their applications may be aware of the available network slices. In such an example, the LAN clients may solicit a network slice initiation through the 5G-CPE 150 after receiving broadcast or multicast messages indicating that network slices are available. For example, the 5G-CPE 150 may advertise indications of the available network slices to the LAN clients. In some implementations, the 5G-CPE 150 may advertise the availability of available network slices using unicast/broadcast messages or a protocol message based on a universal plug-and-play (UPnP) protocol.

The UPnP protocol (developed by the UPnP Forum and published by the International Organization for Standardization (ISO) as ISO/IEC 29341) is just one example of a protocol to support network slice management with a LAN client. The UPnP architecture allows device-to-device networking of consumer electronics, mobile devices, personal computers, and networked home appliances. UPnP control points (CPs) are devices which use UPnP protocols to control UPnP controlled devices (CDs). UPnP allows a device (such as a 5G-CPE 150) to expose a set of functions. An application on the LAN client may operate as or with a CP with the ability to use those functions to invoke for appropriate actions for utilizing a service. Examples of those actions may include creating a slice (“Create Slice”) for a service or deleting a slice (“Delete Slice”) for the service, among other examples. In some implementations, a LAN client may initiate an application session and the 5G-CPE 150 may check the WLAN connection from the LAN client to verify that the WLAN connection can support the QoS needed for the associated with the requested. The 5G-CPE 150 also may validate the user credentials associated with the initiation of the application session. In some implementations, the 5G-CPE 150 may initiate the setup of a network slice on behalf of the STA upon successful verification that the WLAN connection is suitable for the 5QI value and validation of the user credentials. In some implementations, the 5G-CPE 150 may establish a connection via the 5G wireless communication system as part of a successful network slice setup. In some implementations, the 150 may route traffic related to the created or accessed network slice over the established connection.

In some implementations, the 5G-CPE 150 may implicitly determine a need for a network slice to a service of the 5G communication network based on traffic to or from a LAN client. For example, the 5G-CPE 150 may observe traffic destined to certain content providers and infer that a network slice on the 5G wireless communication network is needed. The 5G-CPE 150 may request a network slice on the 5G wireless communication network and maps all the traffic from the LAN client via the network slice to the service. In some implementations, the 5G-CPE 150 may perform a packet inspection to detect domain name service (DNS) requests. Alternatively, or additionally, the 5G-CPE 150 may observe a series of packets directed to a particular network address associated with the service. In some implementations, the 5G-CPE 150 may implement a machine learning (ML) algorithm to determine that a series of packets matches a traffic flow related to a service. When the 5G-CPE 150 determines that the LAN client is sourcing or receiving traffic related to a service, the 5G-CPE 150 may establish a network slice for the service and manage the WLAN traffic flow based on a 5QI value assigned to the network slice.

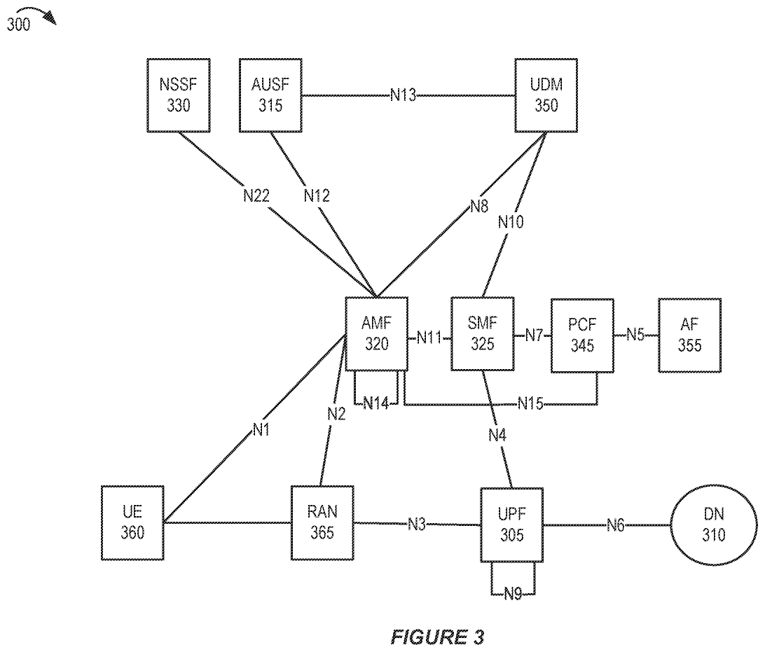

FIG. 3 illustrates an example of a wireless communication system architecture 300. The wireless communication system architecture 300 may include a UE 360, a RAN 365, an UPF 305, a data network 310, an authentication server function (AUSF) 315, an access and mobility management function (AMF) 320, a session management function (SMF) 325, a network slice selection function (NSSF) 330, a PCF 345, a unified data management (UDM) 350, and an application function (AF) 355. The UE 360 may be an example of the UEs 120 and 124 described with reference to FIGS. 1B and 2. In addition, the wireless communication system architecture 300 may include other functions or entities not displayed with reference to FIG. 3 or may not include one or more of the functions or entities shown.

As shown with reference to FIG. 3, the wireless communication system architecture 300 may support LAN clients (such as one or more UEs 360) to participate in a network slice. Specifically, the wireless communication system architecture 300 support the use of network slices to support additional features and network function optimizations. For example, a network slice defined within a public land mobile network (PLMN) may include the core network control plane and the user plane network functions. Network slices may differ for different supported features and different network optimizations. In some examples, an operator may deploy multiple network slice instances delivering the same features but for different groups of UEs (for example, as the different groups of UEs may deliver a different committed service or because the different groups of UEs may be dedicated to a customer). A single UE 360 can simultaneously be served by one or more network slice instances. In some examples, a threshold associated with a number of concurrent slices be set to eight slices, meaning that a single UE 360 may be served by at most eight network slices at a time. The AMF 320 instance serving the UE 360 may logically belong to each of the network slice instances serving the UE 360 (for example, the AMF 320 instance may be common to the network slice instances serving a UE 360).

The selection of the set of network slice instances for a UE 360 (where each of the network slice instances corresponding to network slice selection assistance information, may be triggered by a first contacted AMF as part of one or more procedures, such as a registration procedure. In some examples, the selection of the set of network slice instances may be triggered by interacting with the NSSF 330, and may lead to a change of the AMF 320. Network slice selection assistance information may be used to uniquely determine a network slice. SMF discovery and selection within the selected network slice instance may be initiated by the AMF 320 in response to receiving a session management message from the UE 360. The session management message may include a message to establish a PDU session. In some implementations, different network slice instances may not share a PDU session, though different slices may have slice specific PDU sessions using the same data network name.

The selection of a network slice instance serving a UE 360 and the core network control plane and user plane network functions corresponding to the network slice instance may be the responsibility of a 5G core network. The RAN 365 may use requested network slice selection assistance information in access stratum signaling to handle the UE control plane connection before the 5GC informs the RAN 365 of the allowed network slice selection assistance information. When a UE 360 is successfully registered, the 5G core network may inform the RAN 105 by providing the allowed network slice selection assistance information for the control plane aspects. When a PDU Session is established using a specific network slice instance, the 5G core network may provide to the RAN 365, network slice selection assistance information corresponding to the network slice instance to enable the RAN 365 to perform access specific functions.

In some implementations, the establishment of user plane connectivity to a data network via a network slice instance may include selecting an AlVIF 320 that supports the network slices and establishing one or more PDU sessions to the data network 310 via the network slice instances. When the AMF 320 is selected, the AMF 320 may query the UDM 350 to retrieve UE subscription information including the subscribed network slice selection assistance information.

In some examples, the AMF 320 may be allowed to determine whether it can serve the UE 360 based on a configuration associated with the UE 360. For example, the AMF 320 may be allowed to determine that it can serve the UE 360 based on satisfying at least one parameter associated with the configuration. In addition, the AMF 320 may query the NSSF 330 with requested network slice selection assistance information, an identifier of a subscription permanent identifier (SUPI), location information, and an indication of the access technology used by the UE 360. Based on such information, a local configuration, and other locally available information including RAN capabilities in a registration area, the NSSF 330 may perform one or more operations to select the network slice instances to serve the UE 360. Alternatively, the NSSF 330 may defer the selection of the network slice instance until at least one network slice instance in the registration area are able to serve the UE 360.

In some examples, the set of network slices for a UE 360 may be dynamically changed while the UE 360 is registered with a network. In such examples, the changing of the set of network slices for the UE 360 may be initiated by the network or the UE under various conditions. Based on the operational or deployment plans of an operator, multiple network slice instances associated with common network slice selection assistance information may be deployed in the same registration areas or in different registration areas. In some examples, the registration area allocated by the AMF 320 to the UE 360 may have homogenous support for network slices. When a network slice used for one or multiple protocol data unit sessions becomes no longer available for a UE 360 under the same AMF 320, the AMF 320 may indicate to the SMF 325 to autonomously release the UE 360. In some examples, the establishment of a protocol data unit session in a network slice to the data network 310 may allow data transmission in a network slice.

FIG. 4 illustrates an example timing diagram 400 illustrating a process for managing WLAN QoS to support a 5G network slice. A 5G-CPE 150 may enable connectivity between a UE 124 and a service of a 5G wireless communication network. The service is represented in FIG. 4 by a 5G network 414 and an application provider 416. For brevity, the components of the 5G network 414 are omitted. However, the 5G network 414 may include a base station 110 and some of the network elements described with reference to FIGS. 1B, 2 and 3. In some implementations, the application provider 416 may be similar to the content providers 230, 234, or 238, described with reference to FIG. 2. In some implementations, the 5G-CPE 150 may be a fixed wireless access (FWA) device.

The 5G-CPE 150 may operate a first wireless connection 404 (for example, using 5G radio access technology) between the 5G-CPE 150 and the 5G network 414 and also may operate a second wireless connection 402 (for example, using a WLAN protocol) to the UE 124. The 5G-CPE 150 may establish a 5G wireless connection 410 with the 5G network 414. The 5G wireless connection 410 may include an initial relationship to the application provider 416. Alternatively, or additionally, the 5G network 414 may provide information (such as NSSAI) to the 5G-CPE 150 indicating available services or application providers available via the 5G network 414, including the application provider 416. At 418, the 5G-CPE 150 may analyze the information provided by the 5G network 414 to determine that the application provider 416 is a potential service that can be offered via the second wireless connection 402. In some implementations, the 5G-CPE 150 may advertise the available 5G service via the WLAN. For example, the 5G-CPE 150 may transmit an advertisement message 420 (such as a discovery message, a presence announcement, or other message) to advertise that the 5G-CPE 150 is capable of creating a network slice with the 5G network 414 to access the application provider 416. In some implementations, the advertisement may be formatted to support a UPnP protocol, a broadcast message, or a multicast message, among other examples. The UE 124 may transmit a request 430 for the 5G-CPE 150 to create a 5G network slice to the application provider 416 via the 5G network 414. In some implementations, the request 430 may be formatted as a UPnP protocol message invoking a function (such as “Create Slice”).

At block 440, the 5G-CPE 150 may determine the QoS associated with the requested network slice and enforce one or more preconditions before establishing the requested network slice for the UE 124. For example, the 5G-CPE 150 may determine the 5QI value for the potential network slice. The 5QI value may be in information (such as the NSSAI) received from the 5G network 414. Alternatively, or additionally, the 5G-CPE 150 may obtain the 5QI value from a memory storing a relationship between 5QI values and associated services. As described with reference to FIG. 2, each 5QI value may define a set of end-to-end QoS parameters. Based on the 5QI value, the 5G-CPE 150 may determine whether the type of traffic for the network slice will require a non-GBR, a GBR, or a delay critical GBR. To support the type of traffic and a QoS level associated with the 5QI value, the 5G-CPE 150 may map the 5QI value to a set of WLAN preconditions and settings. For example, the 5G-CPE 150 may require that the UE 124 be connected via a wireless channel in the 6 GHz frequency band before allowing the UE 124 to request a network slice associated with GBR or delay critical GBR traffic. Thus, the 5G-CPE 150 may control whether a particular traffic flow (associated with a value) can be admitted based on which frequency band the WLAN connection. One reason for this precondition is that the 6 GHz frequency band does not support legacy IEEE 802.11 technologies (such as 802.11a/b/g/n/ac) while the 6 GHz frequency band supports newer IEEE 802.11 technologies (such as 802.11ax, 802.11be, or future versions). The newer IEEE 802.11 technologies include some features for MU communication and scheduling that enables the 5G-CPE 150 to better manage the wireless resources. For example, the 5G-CPE 150 may restrict SU traffic which tends to be bursty, time-consuming or inefficient. The 5G-CPE 150 may utilize OFDMA to schedule UL resources for multiple users. Furthermore, the 5G-CPE 150 may manage contention-based settings to give the 5G-CPE 150 or the UE 124 (or both) greater priority to access the wireless channel in the 6 GHz frequency band. Thus, as a practical example, when the requested network slice is for low latency communication (LLC) or URLLC service, the 5QI value for the network slice may indicate that the traffic type is GBR or delay critical GBR, respectively. For such requested network slices, the 5G-CPE 150 may prevent the network slice from being requested when the UE 124 is connected via a legacy frequency band (such as the 2.4 GHz or the 5 GHz frequency bands) because the legacy frequency band may be more likely to experience congestion and transmissions from legacy STAs that would prevent the 150 from supporting a WLAN QoS for the traffic type. In some implementations, when the UE 124 is connected via a legacy frequency band, the 5G-CPE 150 may redirect the UE 124 to connect to a BSS operated by the 5G-CPE 150 in the 6 GHz frequency band. Alternatively, or additionally, the 5G-CPE 150 may send a rejection if the preconditions for granting the request are not satisfied. The precondition that the UE 124 is on the 6 GHz frequency band is one example of a precondition based on the 5QI value of the requested network slice. In some implementations, additional preconditions or other preconditions regarding the WLAN connection may be enforced based on the 5QI value (and related traffic type). For example, in some implementations, the CPE 5G-CPE 150 may grant a request for a particular network slice only when the UE 124 supports a minimum quantity of spatial streams (such as 2 spatial streams). The use of MIMO can improve reliability associated with some traffic types (such as those used for URLLC).

In the example of FIG. 4, the UE 124 is requesting a network slice for a URLLC service provided by the application provider 416. The UE 124 may be connected via a wireless channel in the 6 GHz frequency band, so in block 440, the 5G-CPE 150 may determine to grant the request to establish a network slice for the URLLC service. Therefore, the 5G-CPE 150 may continue with setting up the network slice 450 with the 5G network 414 and the application provider 416.

At block 460, the 5G-CPE 150 may map a traffic flow between the network slice on the 5G wireless connection and the WLAN connection to the UE 124. The traffic flow may be given a high priority queue when the 5QI value of the network slice matches a GBR or delay critical GBR traffic type. The 5G-CPE 150 may schedule traffic for a traffic flow based on the traffic type associated with the 5QI value of the network slice. For example, all the URLLC traffic from the application provider 416 destined to the UE 124 may be queued into a highest priority traffic identifier (TID) of the WLAN. A TID may refer to a QoS class for traffic within a WLAN. One or more traffic flows may be queued in each TID. Those traffic flows assigned to the highest TID will be prioritized over traffic flows for a lower TID. The TID that the 5G-CPE 150 assigns to the traffic flow may depend on traffic type which can be determined based on the 5QI value for the network slice.

At block 460, the 5G-CPE 150 also may adapt a WLAN configuration based on the required WLAN QoS needed to support the 5QI value. For example, for network slices associated with GBR and delay critical GBR traffic, the configure its AIFSN (or the AIFSN of the UE 124, or both) to zero. The arbitration inter-frame spacing (AIFS), in WLAN communications, is a method of prioritizing one Access Category (AC) over the other. AIFS functions by shortening or expanding the period a wireless node (such as the 5G-CPE 150 or the UE 124) has to wait before it is allowed to transmit its next frame. A shorter AIFS period means a message has a higher probability of being transmitted with low latency, which is particularly important for delay-critical data such as voice or streaming video. The AIFSN may be set by the 5G-CPE 150 in an EDCA Parameter set in a beacon and or probe response frame on the WLAN. The 5G-CPE 150 also may adapt the WLAN configuration in other ways. For example, in some implementations, the 5G-CPE 150 can select an MCS that improves reliability when the 5QI value is associated with a GBR or delay critical GBR. Different MCS options may support different levels of reliability or throughput. Typically, a greater reliability may be inversely related with a data rate. While the UE 124 and the 5G-CPE 150 may support a higher data rate (with a higher MCS), the 5QI value may be associated with a QoS for greater reliability. Thus, the 5G-CPE 150 may set an MCS option that has a lower data rate but greater reliability.

The 5G-CPE 150 also may control wireless resources associated with a WLAN connection to the UE 124 to support the 5QI associated with the traffic flow for a network slice. For example, the 5G-CPE 150 may support a traffic flow for URLLC by setting MU-EDCA parameters to suppress SU transmissions. The 5G-CPE 150 may disable the SU transmissions so that only OFDMA (and, optionally MU-MIMO) transmissions are permitted in the BSS that has the WLAN connection to the UE 124. With this approach, the 5G-CPE 150 (as the AP) has full control of the wireless channel and can more readily schedule wireless resources for the UE 124 utilizing a URLLC service. In some implementations, the 5G-CPE 150 may give a higher priority to traffic sent to or received from the UE 124 compared to other STAs (not shown) connected to the 5G-CPE 150. For example, the 5G-CPE 150 may schedule uplink resources for the UE 124 even when a BSR from the UE 124 lacks a sufficient qdepth than would otherwise be needed to schedule uplink resources.

Once the 5G-CPE 150 has mapped the traffic flow for the network slice and configured the WLAN parameters to provide a WLAN QoS that corresponds with the 5QI value (or the traffic type related to the 5QI value), the 5G-CPE 150 may inform the UE 124 that the network slice and traffic flow has been set up. The UE 124 may communicate with the application provider 416 using the WLAN connection 470-A and the 5G network slice 470-B. And, because of the 5G-CPE 150 management of the WLAN settings and scheduling for traffic flow, the end-to-end connection 470 may satisfy the QoS required for the service.

Although the example described with reference to FIG. 4 is based on a URLLC service and a 5QI value for a delay critical GBR, other types of services and 5QI values may be associated with other preconditions or WLAN configurations. Table 2 provides a non-exhaustive list of example services and potentially related 5QI values for each example service. The 5QI values referred to in Table 2 are based on 3GPP technical specification 23.501. Similarly, Table 2 indicates the type of traffic and potential WLAN QoS mapping that may be related to each of the example services (and their respective 5QI values). Furthermore, Table 2 indicates some example WLAN scheduling adaptations that may be made to support the WLAN QoS. Some of the example services in Table 2 are not yet defined in the 3GPP specifications and may be associated with an SST not yet defined. Table 2 is provided as an example and not intended to include all of the potential services, 5QI values, and corresponding WLAN QoS handling options that are possible.

TABLE 2

| Example | | | | Example | |
|---|---|---|---|---|---|
| services | | | | WLAN | |
| (network | | Type of | WLAN QoS | scheduler | |
| slice type) | 5QI value | traffic | Mapping | handling | Remarks |
| eMBB | 5, 6, 7, 8, 9, 69, | Non-GBR | Standard TID | No | Standard |
| | 70, 79 | | mapping (VI, | special | eMBB SST |
| | | | VO, BE, BK) | handling | (1) |
| eMBB with low | 80 | Non-GBR | Highest | Schedule | New SST |
| latency | | | priority TID | using | value may |
| | | | | OFDMA | be defined |
| | | | | & AIFSN = | for this |
| | | | | 0 | service |
| | | | | Schedule | |
| | | | | the STA | |
| | | | | traffic | |
| | | | | even if | |
| | | | | qdepth is | |
| | | | | low | |
| LLC (Low | 1, 2, 3, 4, 65, 66, | GBR | Highest | No | New SST |
| latency | 67, 75, 71, 72, | | priority TID | special | value may |
| communication) | 73, 74, 76 | | | handling | be defined |
| | | | | | for this |
| | | | | | service |
| URLLC with | 82, 83, 84, 85, 86 | Delay | Highest | Schedule | Standard |
| ultra-low | | Critical GBR | priority TID | using | URLLC |
| latency | | | | OFDMA | SST (2) |
| | | | | & AIFSN = | |
| | | | | 0 | |
| | | | | Schedule | |
| | | | | the STA | |
| | | | | traffic | |
| | | | | even if | |
| | | | | qdepth is | |
| | | | | low | |

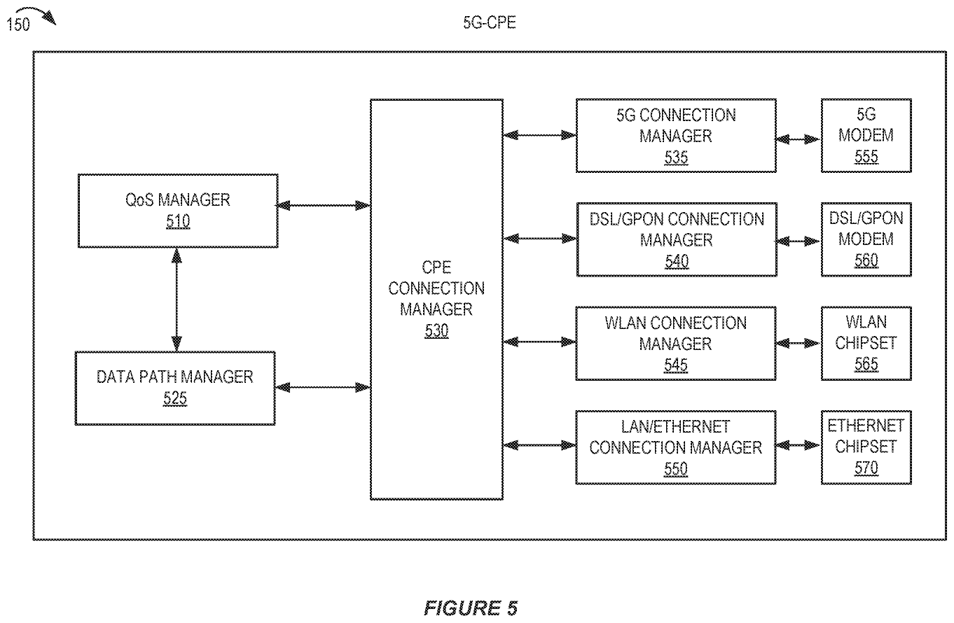

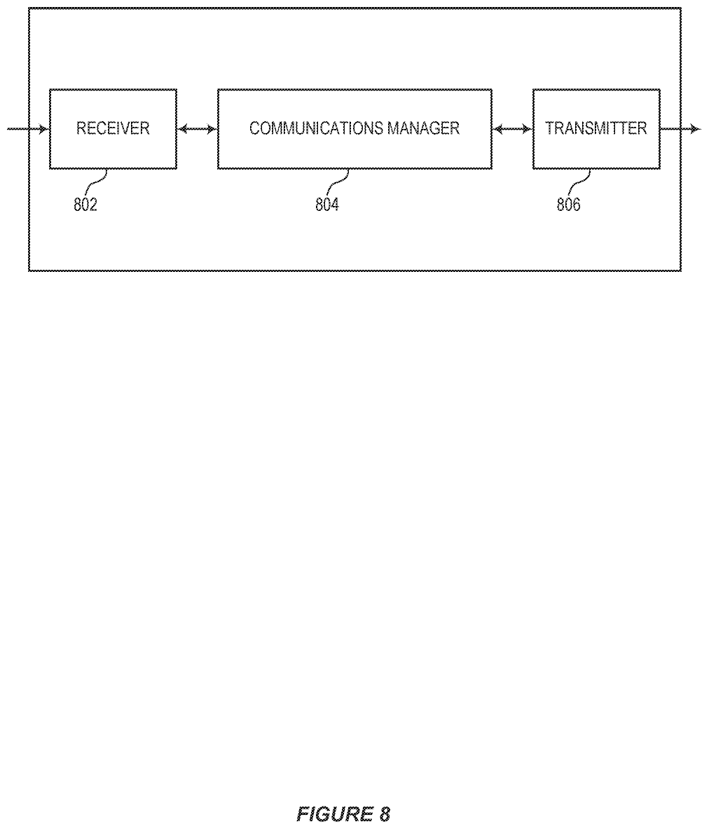

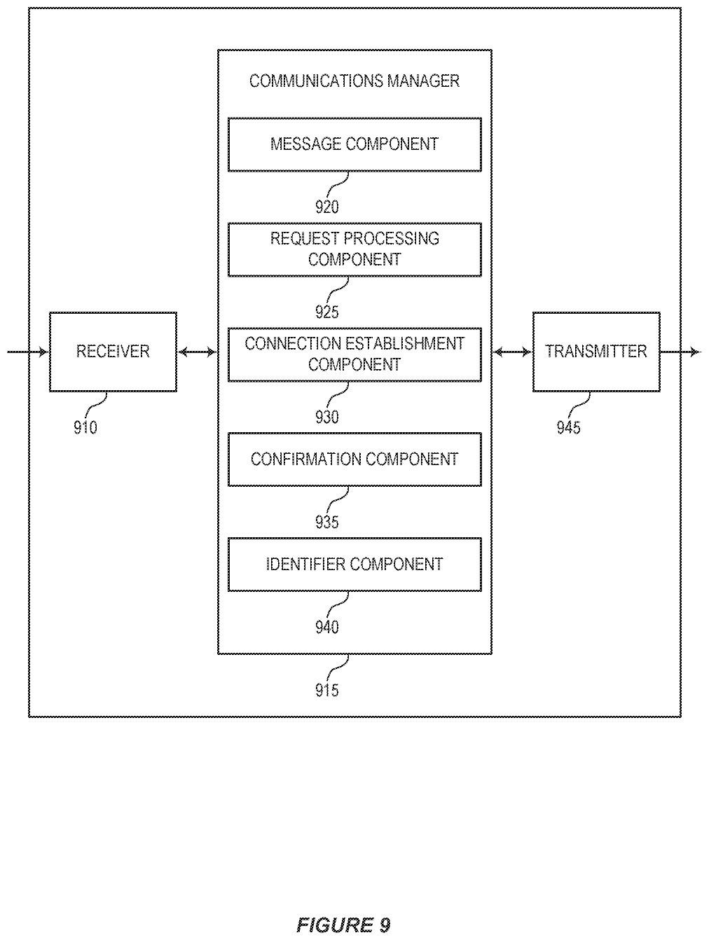

FIG. 5 shows a block diagram of an example 5G-CPE 150 that supports techniques for LAN clients participation in a 5G network slice. In some implementations, the 5G-CPE 150 is configured to perform one or more of the processes illustrated in timing diagrams 400 and 600, or any of the processes 1200, and 1300 described above with reference to FIGS. 4, 6, 12, and 13, respectively. In some implementations, the 5G-CPE 150 can be an example implementation of a wireless communication device described herein with reference to FIG. 8 or a wireless communication device described herein with reference to FIG. 9. For example, the 5G-CPE 150 can be a chip, SoC, chipset, package or device that includes at least one processor, a Wi-Fi (IEEE 802.11) modem, and a cellular modem. In some implementations, the 5G-CPE 150 can be, or can include, an AP (such as AP 102) for serving one or more WLANs such as using a WLAN. The 5G-CPE 150 also may include a 5G modem for communicating with a 5G wireless communication system.

The 5G-CPE 150 may include a QoS manager 510, a data path manager 525, a CPE connection manager 530, and one or more components (which may be referred to as LAN or wide area network (WAN) interfaces) for establishing wired or wireless connections with other devices. For example, the LAN or WAN interfaces may include any combination of a 5G connection manager 535, a digital subscriber line (DSL)/gigabit passive optical network (GPON) connection manager 540, a WLAN connection manager 545, a LAN or Ethernet connection manager 550, a 5G modem 555, a DSL/GPON modem 560, a WLAN chipset 565, and an Ethernet chipset 570. Portions of one or more of the modules 510, 525, 530, 535, 540, 545, 550, 555, 560, 565, and 570 may be implemented at least in part in hardware or firmware. In some implementations, at least some of the modules 510, 525, 530, 535, 540, 545, 550, 555, 560, 565, and 570 are implemented at least in part as software stored in a memory. For example, portions of one or more of the modules 510, 525, 530, 535, 540, 545, 550, 555, 560, 565, and 570 can be implemented as non-transitory instructions (or “code”) executable by a processor to perform the functions or operations of the respective module.

The CPE connection manager 530 may be configured to setup connections between the LAN and WAN interfaces. As depicted with reference to FIG. 5, the WAN interfaces may include a 5G WAN interface and a DSL/GPON WAN interface. In some implementations, the 5G WAN interface and the DSL/GPON WAN interface may be referred to as hybrid WANs. In some examples, such hybrid WANs may be used by the 5G-CPE 150. In some implementations, the CPE connection manager 530 may be configured to perform traffic switching and traffic steering. Additionally, or alternatively, the CPE connection manager 530 may be configured to setup one or more channels across multiple LAN and WAN interfaces. In some implementations, the CPE connection manager 530 may be configured to setup or terminate (for example, tear down) connections with the network or with one or more WLAN clients (such as STA 104). According to some implementations, the CPE connection manager 530 in conjunction with the QoS manager 510, may setup or terminate one or more connections (as further described with reference to FIG. 5).

The QoS manager 510 may be configured to determine whether new traffic flows may be admitted into an existing traffic flow. A traffic flow is logical relationship between a LAN client connected to a LAN interface and a network slice established via a WAN interface. Each traffic flow may be configured to support the 5QI for a network slice. The QoS manager 510 may be configured to control admission of new traffic flows and sustain the committed traffic flows. In some examples, the QoS manager 510 may be configured to determine one or more QoS parameters (or 5QI value) associated with a 5G network (such as a 5G WAN or a 5G WLAN). In such implementations, the QoS manager 510 may be configured to coordinate the traffic flows on the LAN (such as Ethernet and Wi-Fi) as well as the 5G WAN or the 5G WLAN (such as DSL/GPON). In some examples, QoS manager 510 may be configured to coordinate the traffic flows using one or more committed QoS parameters. In some implementations, the QoS manager 510 may be configured to determine resource allocations (such as a buffer resource allocation) within 5G-CPE 150. In some examples, the QoS manager 510 may be configured to determine random access memory (RAM) supported by various interfaces and data rates supported by various interfaces. In some examples, the QoS manager 510 may be configured to optimize the resources within the 5G-CPE 150. In some examples, the QoS manager 510 may be configured to tag the resources to multiple states (such as green, yellow, and red) on a periodic basis to facilitate decision making during an admission of a traffic flow associated with a session or a network slice. Additionally, or alternatively, the QoS manager 510 may be configured to tag the resources to multiple states to effectively sustain a session or a network slice.

As shown with reference to FIG. 5, the CPE connection manager 530, the QoS manager 510, and the data path manager 525 may be coupled with each other, and may be configured to transmit and receive one or more commands and notifications. In some implementations, the data path manager 525 may be configured to handle traffic, including traffic switching, maintaining traffic statistics, and transmitting and receiving traffic on various interfaces. In some examples, the data path manager 525 may be configured to manage traffic received or transmitted using a combination of the 5G connection manager 535, the DSL/GPON connection manager 540, the WLAN connection manager 545, the LAN or Ethernet connection manager 550, the 5G modem 555, the DSL/GPON modem 560, the WLAN chipset 565, and the Ethernet chipset 570. In some examples, the 5G modem 555 may be coupled with a UE route selection policy (URSP) daemon (not shown). The URSP daemon may be configured to manage a route selection policy for a UE. In some examples, the URSP daemon may be configured to receive one or more updates to the route selections resulting from network changes including changes initiated by a Policy and Charging Framework (PCF). In some examples, the URSP daemon may be configured to receive one or more updates at a run-time. Additionally, or alternatively, the URSP daemon may be configured to track all the slice selection assistance information (such as network slice selection assistance information, configured slice selection assistance information, or allowed slice selection assistance information).

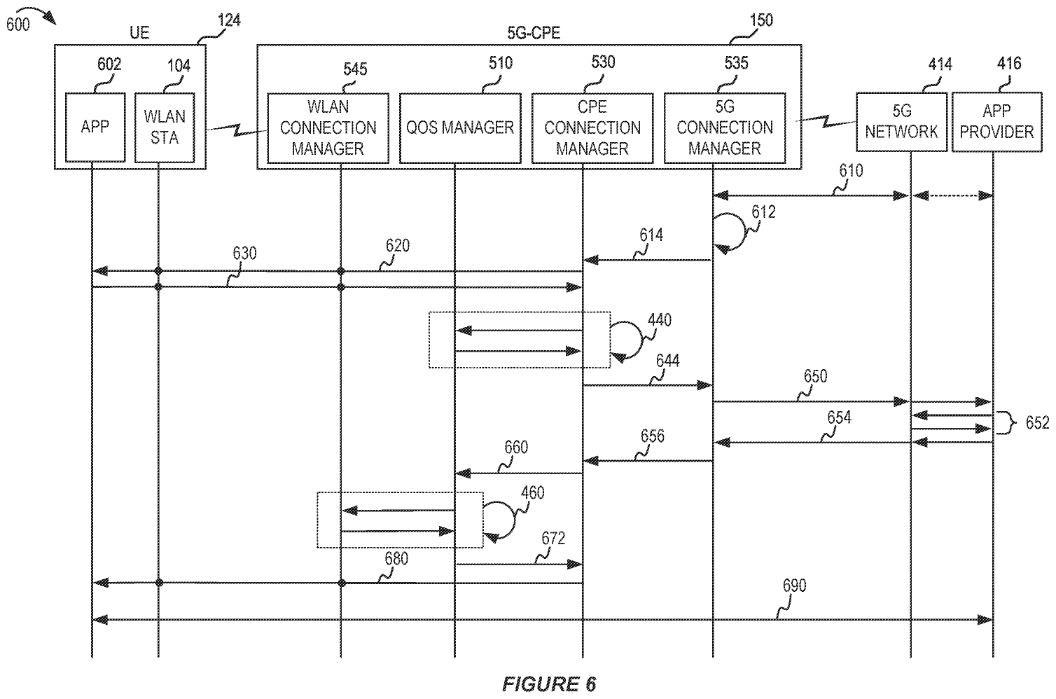

FIG. 6 shows an example timing diagram 600 illustrating a process in which a 5G-CPE manages a WLAN based on a QoS for a 5G network slice. The timing diagram 600 includes a UE 124, a 5G-CPE 150, a wireless communication network (such as 5G network 414), and an application provider 416. The UE 124 and the 5G-CPE 150 may be examples of the corresponding devices described with reference to FIGS. 1A, 1B, 2, 4 and 5. The UE 124 may include an application 602 and a STA 104 interface configured to communicate in a WLAN. The 5G-CPE 150 may include a CPE connection manager 530, a 5G connection manager 535, a QoS manager 510, and a WLAN connection manager 545. Each of the components included in the 5G-CPE 150 may be examples of the corresponding devices described with reference to FIG. 5. For brevity, the physical layer (PHY) interfaces (such as the 5G modem for the 5G connection manager 535 and the WLAN chipset for the WLAN connection manager 545) are not illustrated. Alternative examples of the timing diagram 600 may be implemented, in which some steps may be performed in a different order than described, some steps may be added, or some steps may not be performed at all. In some implementations, steps may include additional features not described below.

The 5G-CPE 150 may establish a 5G wireless connection 610 with the 5G network 414. The 5G wireless connection 610 may include an initial relationship to the application provider 416. For example, the 5G connection manager 535 may communicate via a 5G modem (not shown) with a base station (not shown) of the 5G network 414 to request a 5G wireless connection 610. During or after a setup of the 5G wireless connection 610, the 5G connection manager 535 may receive information (such as NSSAI) that indicates which potential services (such as SSTs) are available via the 5G network 414. At 612, the 5G connection manager 535 may analyze (one time or iteratively) the received information to determine an available network slice from a set of network slices supported by the 5G network 414. In some implementations, an URSP daemon (not shown) of the 5G modem may obtain the network slice selection assistance information and may forward the network slice selection assistance information to the 5G connection manager 535. The 5G connection manager 535 may analyze the network slice selection assistance information and determine the available network slices. At 614, the 5G connection manager 535 may inform the CPE connection manager 530 of the available network slice.

The CPE connection manager 530 may prepare and communicate an advertisement message 620 or messages to the UE 124. For example, the CPE connection manager 530 may prepare a UPnP protocol message that advertises the available network slice. The CPE connection manager 530 may cause the message 620 to be transmitted via the WLAN connection manager 545 (and its corresponding WLAN interface, not shown) to the STA 104 of the UE 124. Thus, the 5G-CPE 150 may advertise the available network slice to the UE 124 via a WLAN connection. In some implementations, the 5G-CPE 150 may provide an option to a user operating the UE 124 to provide credentials for accessing or establishing a network slice. In some implementations, the message 620 may be a multicast message or a broadcast message.

The UE 124 may communicate a request to use a network slice of the 5G network to access the advertised service. For example, an application 602 of the UE 124 may communicate a request message 630 to the CPE connection manager 530. The request message 630 may be communicated via the WLAN connection (including the STA 104 to a WLAN interface, not shown, operated by the WLAN connection manager 545 of the 5G-CPE 150). In some implementations, the request message 630 may be formatted as a UPnP protocol message. For example, the request message 630 may be a “Create Slice” message via the UPnP protocol between the application 602 and the CPE connection manager 530. In some implementations, the UE 124 may transmit one or more credentials (such as one or more identifiers) to the 5G-CPE 150. If the user of the 5G-CPE 150 (for example, the UE 124 or a user operating the UE 124) provides the credentials for accessing the available network slices, the 5G-CPE 150 may program one or more rules in the CPE connection manager 530 to filter requests associated with configured services or configured network slices. The rules may filter the request and may forward the requests to the CPE connection manager 530.

In some implementations, the WLAN connection manager 545 may determine that an application on the UE 124 has initiated an application session (for example, using domain name system or deep packet inspection or both). The WLAN connection manager 545 may be configured to track the request and share the request with the CPE connection manager 530. The CPE connection manager 530 may request validation of the credentials with 5G connection manager 535 to determine whether the provided credentials match one or more pre-configured credentials. In an example in which the credentials do not match, the CPE connection manager 530 may allocate the data flow (such as the data flow associated with the initiated application session) to a default packet data network. Otherwise, if the credentials match, the CPE connection manager 530 may check with the QoS manager 510 to see if WLAN preconditions are satisfied or whether the WLAN can support a service level agreement (SLA) associated with the QoS for the requested network slice.

Shown at 440, the CPE connection manager 530 may inform the QoS manager 510 of the requested network slice and determine, in coordination with the QoS manager 510 whether the WLAN can support a QoS requirement for the network slice. The features at 440 may be similar to the corresponding block 440 described with reference to FIG. 4. For example, the QoS manager 510 may determine a 5QI value associated with the requested network slice. Based on the 5QI value, the QoS manager 510 may determine a traffic type and preconditions for the WLAN before the request for the network slice is granted. As an example, the QoS manager 510 may enforce a precondition that the WLAN connection between the STA 104 and the WLAN connection manager 545 is established on a 6 GHz frequency band when the requested network slice has a 5QI value associated with GBR or delay critical GBR traffic. Thus, the preconditions enforced by the QoS manager 510 may relate to the ability of the WLAN connection manager 545 to manage the QoS of the WLAN connection to meet QoS for the network slice. In some implementations, the QoS manager 510 may determine whether a data flow associated with requested network slice can be admitted into a data queue, based on a policy associated with the requested network slice. The QoS manager 510 may inform the CPE connection manager 530 whether the request for the network slice can be granted or not. In the example of FIG. 6, the QoS manager 510 may determine to permit the creation of the requested network slice because the WLAN precondition is satisfied in the example shown in FIG. 6.

The CPE connection manager 530 may transmit an instruction or request to the 5G connection manager 535 to setup the network slice with the 5G network 414. Upon receiving the instruction or request from the CPE connection manager 530 for the requested network slice approved by the QoS manager 510, the 5G connection manager 535 may transmit a slice setup request message 650 to the application provider 416 via the 5G network 414 to setup a network slice for the service. In some implementations, shown at 652, the application provider 416 and the 5G network 414 may coordinate with one or more components of the 5G network 414 to setup the network slice. At 654, the 5G connection manager 535 may receive a confirmation that the network slice has been setup successfully in the 5G network 414.

At 656, the 5G connection manager 535 may inform the CPE connection manager 530 that the network slice has been setup with the 5G network 414. The CPE connection manager 530 may invoke a process (shown as block 460) in which the QoS manager 510 may map the network slice to a traffic flow and configure the WLAN connection manager 545 with WLAN settings to satisfy the QoS for the network slice. The features at 460 may be similar to the corresponding block 460 described with reference to FIG. 4. For example, the QoS manager 510 may map the network slice to a traffic flow having a TID priority to satisfy the 5QI value of the network slice. As an example, for a network slice having a 5QI value associated with GBR or delay critical GBR traffic, the QoS manager 510 may map the traffic flow to a highest TID so that the WLAN traffic for that network slice will have the highest priority class in the WLAN connection manager 545. Furthermore, the QoS manager 510 may configure one or more WLAN settings to satisfy the QoS of the 5QI value for the network slice. Referring again to the example network slice having a 5QI value associated with GBR and delay critical GBR traffic, the QoS manager 510 may cause the WLAN connection manager 545 to configure an AIFSN equal to zero so that the packets for that network slice will have the greatest chance of obtaining wireless resources in the WLAN connection between the WLAN connection manager 545 and the STA 104. The QoS manager 510 may cause the WLAN connection manager 545 to send a message in the BSS to disable SU access mode and force OFDMA access for enhanced scheduling. In some implementations, the QoS manager 510 may cause the WLAN connection manager 545 to use a minimum quantity of spatial streams in MU-MIIVIO transmissions that include packets for the traffic flow mapped to the network slice. The process by which the QoS manager 510 configures the WLAN settings of the WLAN connection manager 545 may vary. In some implementations, the QoS manager 510 may communicate settings to the WLAN connection manager 545. Alternatively, or additionally, the QoS manager 510 may provide the 5QI value or related QoS requirements to the WLAN connection manager 545 and the WLAN connection manager 545 may perform the traffic flow mapping and WLAN configuration based on the provided 5QI value or QoS requirement.

After modifying the WLAN parameters of the WLAN connection manager 545 to support the 5QI of the network slice, at 672, the QoS manager 510 may inform the CPE connection manager 530 that the network slice mapping was successful. The CPE connection manager 530 may inform the UE 124 (such as the application 602) that the network slice has been setup and the traffic flow has been mapped to an appropriate quality of service feature set in the WLAN connection manager 545. Thereafter, the application 602 may communicate 690 with the application provider 416 via the WLAN connection to the 5G-CPE 150 and the 5G connection between the 5G-CPE 150 and the 5G network 414. An end-to-end quality of service for the traffic flow (including the WLAN connection and the 5G connection) may satisfy the QoS requirements of the 5QI value of the network slice.

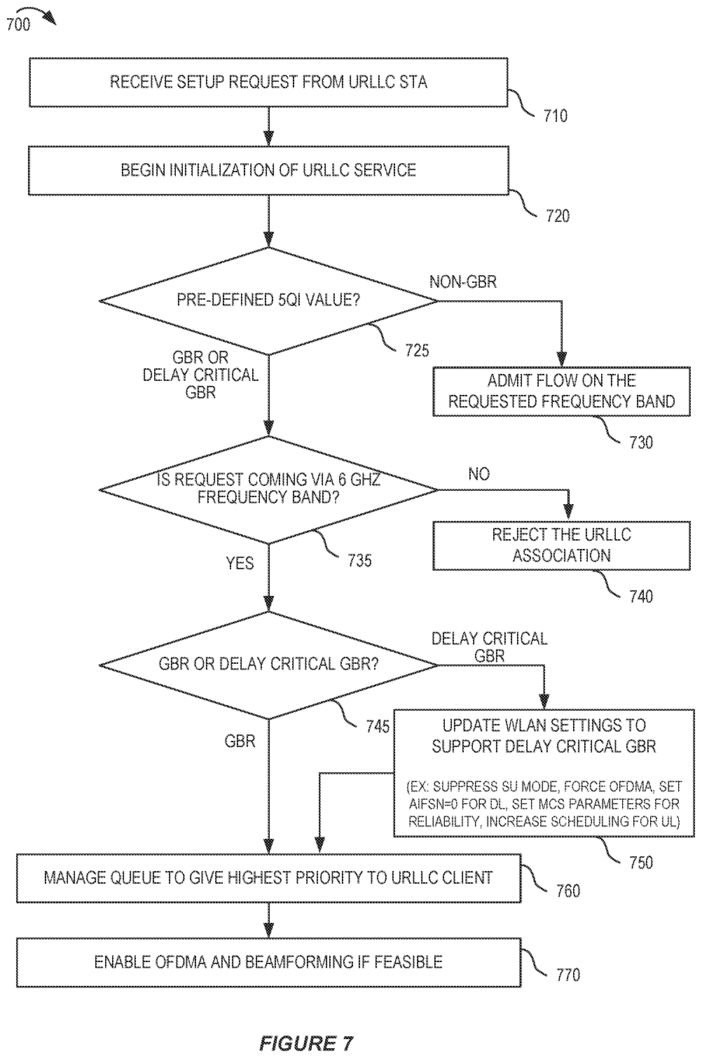

FIG. 7 a flowchart illustrating an example process for managing a WLAN connection based on quality of service (QoS) for a service of a wireless communication system. In some implementations, the process 700 may be performed by an 5G-CPE such as the 5G-CPE 150 described with reference to FIGS. 1B, 2, 4 and 5, respectively. In some implementations, the process 700 may be performed by a wireless communication device such any of the devices described with reference to FIGS. 8, 9, 10, 11 and 15. For brevity, the example process 700 is described as being performed by an apparatus that could be any of the above indicated UEs, wireless communication devices, or a component thereof.

In block 710, the apparatus may receive a setup request from a STA requesting a URLLC service. In block 720, the apparatus may begin an initialization of the URLLC service with a 5G wireless communication system. For example, the apparatus may establish a network slice with the 5G wireless communication system for access to the URLLC service.

In block 725, the apparatus may determine the QoS associated with the network slice. For example, the apparatus may determine the 5QI value associated with the service. In some examples, the 5QI value (such as a 5QI value of 80 or greater) may define QoS parameters for GBR or delay critical GBR traffic to support the URLLC service. In other examples, the 5QI value may define QoS parameters for non-GBR traffic for a different service. If the 5QI value is associated with non-GBR traffic, the process 700 may continue to block 730. At block 730, the apparatus may admit the traffic flow on whatever frequency band the request was received. For example, the apparatus may not perform special handling of the WLAN resources because the non-GBR traffic may not require modifications of the default handling. Otherwise, in block 725, if the 5QI value is associated with a GBR or delay critical GBR traffic, the process 700 may continue to block 735.

In block 735, the apparatus may determine whether the request was received via a wireless channel in the 6 GHz frequency band. If the request was received in a legacy frequency band (such as 2.4 GHz or 5 GHz), the process 700 may continue to block 740 in which the apparatus may reject the URLLC association. Otherwise, fi the request was received via a wireless channel in the 6 GHz frequency band, the process 700 may continue to block 745.

In block 745, the apparatus may determine whether the 5QI is associated with GBR or delay critical GBR. If the 5QI is associated with a delay critical GBR, the process 700 may continue to block 750. Otherwise, the process 700 may continue to block 760.

In block 750, because the 5QI is associated with a delay critical GBR, the apparatus may update WLAN settings to better support the QoS requirements for delay critical GBR traffic. For example, the apparatus may modify how it handles scheduling for uplink and downlink transmissions to support the delay critical GBR traffic. For example, the apparatus may set MU-EDCA to suppress SU transmissions. For downlink traffic, the apparatus may set the AIFSN of the 5G-CPE to a low value (such as zero) to give the 5G-CPE a higher chance of utilizing the wireless resources for the delay critical GBR traffic as compared to other traffic flows or other devices in the WLAN. In some implementations, the apparatus may select a lower MCS value to increase reliability of the transmissions that include the delay critical GBR traffic. The apparatus may schedule the uplink traffic for the URLLC service using a higher priority, a lower BSR qdepth threshold, shorter a trigger frame periodicity, or any combination thereof. After updating the scheduling parameters for the traffic flow to support delay critical GBR, the process 700 may continue to block 760.

In block 760, the apparatus may manage its queues to give highest priority to a URLLC traffic flow for the STA. For example, the apparatus may queue all downlink packets to the STA using a highest TID.

In block 770, the apparatus may enable OFDMA, MIMO, and beamforming if those features are supported by the STA.

The example techniques to manipulate WLAN quality of service described with reference to FIG. 7 are provided for pedagogical purposes. Other techniques may be used in various combinations to manage the QoS provided to a STA accessing a wireless communication network service via the WLAN.

FIG. 8 shows a block diagram of an example wireless communication device that supports techniques for managing a WLAN connection based on a QoS for a network slice. In some implementations, the wireless communication device is configured to perform one or more of the processes illustrated in timing diagrams 400 and 600, or any of the processes 1200, and 1300 described above with reference to FIGS. 4, 6, 12, and 13, respectively. In some implementations, the wireless communication device can be an example implementation of a 5G-CPE 150 described herein with reference to FIGS. 1B, 2, 4, 5 and 6 or a wireless communication device described herein with reference to FIG. 9. For example, the wireless communication device can be a chip, SoC, chipset, package or device that includes at least one processor, a Wi-Fi (IEEE 802.11) modem, and a cellular modem.

In some implementations, the wireless communication device can be a CPE or a device for use in a CPE (as such, the wireless communication device may hereinafter be referred to as CPE). In some implementations, the CPE can be, or can include, an AP (such as AP 102) for serving one or more WLANs such as using a Wi-Fi network or a 5G network.

The wireless communication device may include a receiver 802, a communications manager 804, and a transmitter 806. Portions of one or more of the modules 802, 804, and 806 may be implemented at least in part in hardware or firmware. In some implementations, at least some of the modules 802, 804, and 806 are implemented at least in part as software stored in a memory. For example, portions of one or more of the modules 802, 804, and 806 can be implemented as non-transitory instructions (or “code”) executable by a processor to perform the functions or operations of the respective module.

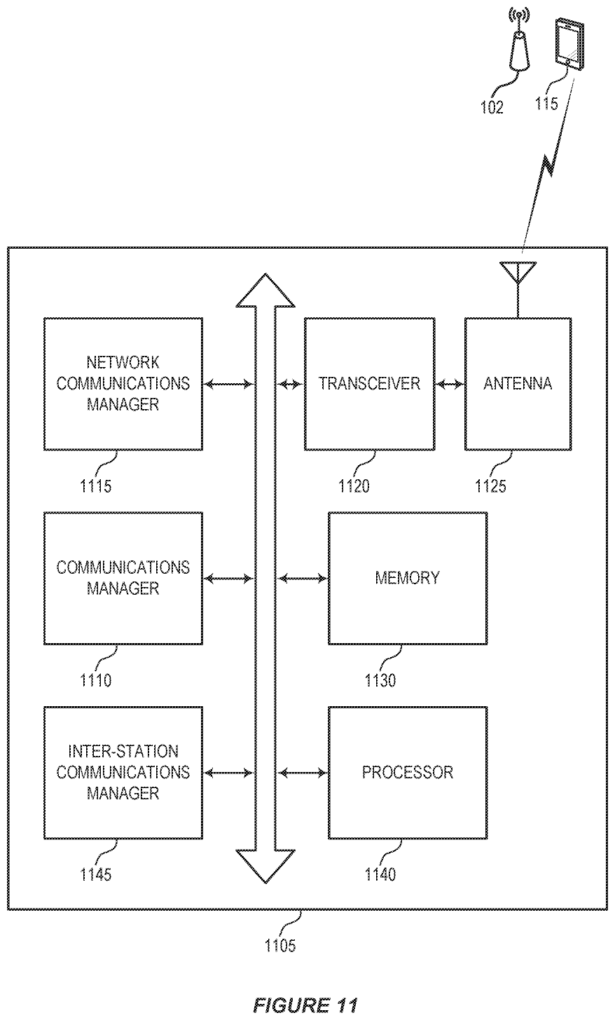

The receiver 802 is configured to receive information such as packets, user data, or control information associated with various information channels (for example, control channels, data channels, and information related to participation of LAN clients in a network slice). Information may be passed on to other components of the device. The receiver 802 may be an example of aspects of the transceiver 1120 described with reference to FIG. 11. The receiver 802 may utilize a single antenna or a set of antennas.

The communications manager 804 may transmit, to one or more LAN clients of the device, a multicast message indicating an available network slice. The communications manager 804 may receive, from a first LAN client of the one or more LAN clients based on the multicast message, a request to access the available network slice and establish, at the wireless communication device based on receiving the request, a connection associated with the available network slice. The communications manager 804 may transmit, to the first LAN client based on establishing the connection, a confirmation to access the available network slice.

The communications manager 804 also may transmit, to one or more LAN clients of the device, a multicast message indicating an available network slice. The communications manager 804 may receive, from a first LAN client of the one or more LAN clients based on the multicast message, an identifier associated with the available network slice, establish, at the device based on a successful validation of the identifier, a connection associated with the available network slice, and transmit, to the first LAN client based on establishing the connection, a confirmation to access the available network slice. The communications manager 804 may be an example of aspects of the communications manager 1110 described herein.

The transmitter 806 may transmit signals generated by other components of the device. In some examples, the transmitter 806 may be collocated with a receiver 802 in a transceiver module. For example, the transmitter 806 may be an example of aspects of the transceiver 1120 described with reference to FIG. 11. The transmitter 806 may utilize a single antenna or a set of antennas.

FIG. 9 shows a block diagram of an example wireless communication device that supports techniques for managing a WLAN connection based on a QoS for a network slice. In some implementations, the wireless communication device is configured to perform one or more of the processes illustrated in timing diagrams 400 and 600, or any of the processes 1200 and 1300 described above with reference to FIGS. 4, 6, 12 and 13, respectively. In some implementations, the wireless communication device can be an example implementation of a 150 described herein with reference to FIGS. 1B, 2, 4, 5 and 6 or a wireless communication device described herein with reference to FIG. 8. For example, the wireless communication device can be a chip, SoC, chipset, package or device (such as a CPE) that includes at least one processor, a Wi-Fi (IEEE 802.11) modem, and a cellular modem).

In some implementations, the wireless communication device can be a CPE or a device for use in a CPE (as such, the wireless communication device may hereinafter be referred to as CPE). In some implementations, the CPE can be, or can include, an AP (such as AP 102) for serving one or more WLANs such as using a Wi-Fi network or a 5G network.

The wireless communication device includes a receiver 910, a communications manager 915, a message component 920, a request processing component 925, a connection establishment component 930, a confirmation component 935, an identifier component 940, and a transmitter 945. Portions of one or more of the modules 910, 915, 920, 925, 930, 935, 940, and 945 may be implemented at least in part in hardware or firmware. In some implementations, at least some of the modules 910, 915, 920, 925, 930, 935, 940, and 945 are implemented at least in part as software stored in a memory. For example, portions of one or more of the modules 910, 915, 920, 925, 930, 935, 940, and 945 can be implemented as non-transitory instructions (or “code”) executable by a processor to perform the functions or operations of the respective module.

The receiver 910 may receive information such as packets, user data, or control information associated with various information channels (for example, control channels, data channels, and information related to participation of LAN clients in a network slice). Information may be passed on to other components of the device. The receiver 910 may be an example of aspects of the transceiver 1120 described with reference to FIG. 11. The receiver 910 may utilize a single antenna or a set of antennas.

The communications manager 915 may be an example of aspects of the communications manager 804 as described herein. The communications manager 915 804 is configured to include a message component 920, a request processing component 925, a connection establishment component 930, a confirmation component 935, and an identifier component 940. The communications manager 915 may be an example of aspects of the communications manager 1110 described herein.

The message component 920 is configured to transmit, to one or more LAN clients of the device, a multicast message indicating an available network slice. The request processing component 925 is configured to receive, from a first LAN client of the one or more LAN clients based on the multicast message, a request to access the available network slice.

The connection establishment component 930 is configured to establish, at the device based on receiving the request, a connection associated with the available network slice. The confirmation component 935 is configured to transmit, to the first LAN client based on establishing the connection, a confirmation to access the available network slice.

The message component 920 is configured to transmit, to one or more LAN clients of the device, a multicast message indicating an available network slice. The identifier component 940 is configured to receive, from a first LAN client of the one or more LAN clients based on the multicast message, an identifier associated with the available network slice.

The connection establishment component 930 is configured to establish, at the device based on a successful validation of the identifier, a connection associated with the available network slice. The confirmation component 935 is configured to transmit, to the first LAN client based on establishing the connection, a confirmation to access the available network slice.

The transmitter 945 is configured to transmit signals generated by other components of the device. In some examples, the transmitter 945 may be collocated with a receiver 910 in a transceiver module. For example, the transmitter 945 may be an example of aspects of the transceiver 1120 described with reference to FIG. 11. The transmitter 945 may utilize a single antenna or a set of antennas.

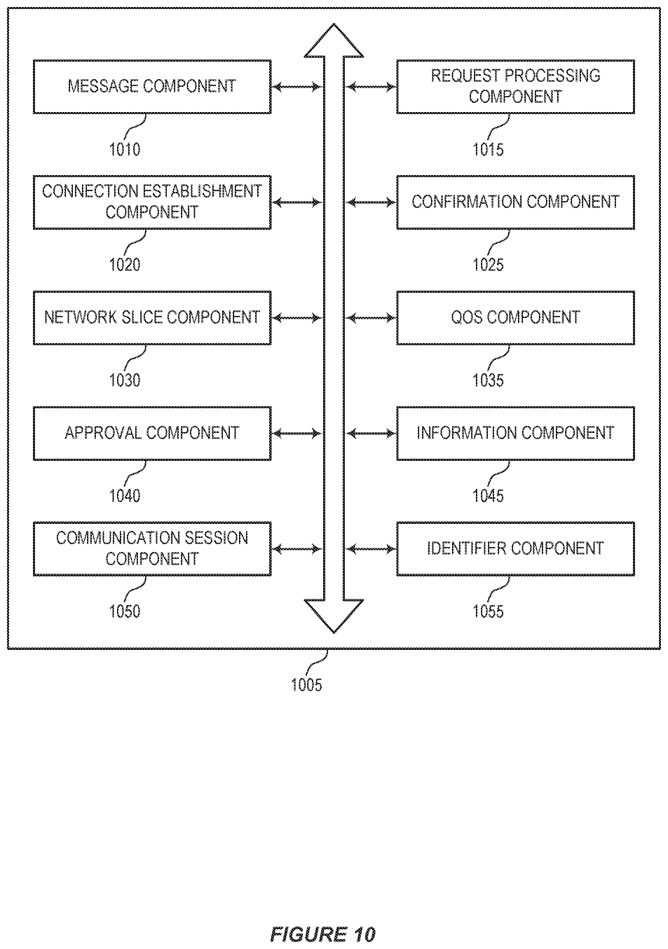

FIG. 10 shows a block diagram of an example wireless communication device that supports techniques for managing a WLAN connection based on a QoS for a network slice. In some implementations, the wireless communication device is configured to perform one or more of the processes illustrated in timing diagrams 400 and 600, or any of the processes 1200 and 1300 described above with reference to FIGS. 4, 6, 12 and 13, respectively. In some implementations, the wireless communication device can be an example implementation of a 150 described herein with reference to FIGS. 1B, 2, 4, 5 and 6 or a wireless communication device described herein with reference to FIG. 8 or a wireless communication device described herein with reference to FIG. 9. For example, the wireless communication device can be a chip, SoC, chipset, package or device (such as a CPE) that includes at least one processor, a Wi-Fi (IEEE 802.11) modem, and a cellular modem.

In some implementations, the wireless communication device can be a CPE or a device for use in a CPE (as such, the wireless communication device may hereinafter be referred to as CPE). In some implementations, the CPE can be, or can include, an AP (such as AP 102) for serving one or more WLANs such as using a Wi-Fi network or a 5G network.

The wireless communication device includes a message component 1010, a request processing component 1015, a connection establishment component 1020, a confirmation component 1025, a network slice component 1030, a QoS component 1035, an approval component 1040, an information component 1045, a communication session component 1050, and an identifier component 1055. Portions of one or more of the modules 1010, 1015, 1020, 1025, 1030, 1035, 1040, 1045, 1050, and 1055 may be implemented at least in part in hardware or firmware. In some implementations, at least some of the modules 1010, 1015, 1020, 1025, 1030, 1035, 1040, 1045, 1050, and 1055 are implemented at least in part as software stored in a memory. For example, portions of one or more of the modules 1010, 1015, 1020, 1025, 1030, 1035, 1040, 1045, 1050, and 1055 can be implemented as non-transitory instructions (or “code”) executable by a processor to perform the functions or operations of the respective module.

The message component 1010 is configured to transmit, to one or more LAN clients of the device, a multicast message indicating an available network slice. In some examples, the message component 1010 is configured to transmit, to one or more LAN clients of the device, a multicast message indicating an available network slice. In some implementations, the multicast message includes one or more of broadcast messages or universal plug-and-play messages.

The request processing component 1015 is configured to receive, from a first LAN client of the one or more LAN clients based on the multicast message, a request to access the available network slice. The connection establishment component 1020 is configured to establish, at the device (such as a CPE) based on receiving the request, a connection associated with the available network slice. The confirmation component 1025 may transmit, to the first LAN client based on establishing the connection, a confirmation to access the available network slice.

The network slice component 1030 is configured to determine one or more data packets associated with the available network slice. The QoS component 1035 is configured to determine whether the one or more data packets satisfy a QoS threshold, where establishing the connection associated with the available network slice is based on determining that the one or more data packets satisfy the QoS threshold.

In some examples, the request processing component 1015 is configured to transmit, to a network device based on receiving the request, a second request to access the available network slice. In some examples, the confirmation component 1025 is configured to receive, from the network device, a confirmation to access the available network slice, where establishing the connection associated with the available network slice is based on receiving the confirmation from the network device, and where the confirmation transmitted to the first LAN client is based on the confirmation received from the network device.

In some examples, the network slice component 1030 is configured to receive, from the network device, information associated with a set of network slices based on transmitting the request. In some examples, the network slice component 1030 is configured to delete the second network slice based on receiving the second request.

In some examples, the request processing component 1015 is configured to receive, from the first LAN client, a second request to create a new network slice, where the second request is based on the multicast message. The approval component 1040 is configured to determine an approval status associated with the new network slice. In some examples, the request processing component 1015 is configured to transmit, to a network device based on determining the approval status, a third request to access the new network slice. In some examples, the confirmation component 1025 is configured to receive, from the network device based on transmitting the third request, a confirmation to access the new network slice.

In some examples, the message component 1010 is configured to transmit the multicast message is based on determining the available network slice. In some examples, the message component 1010 is configured to transmit, to the first LAN client based on receiving the indication of the released slice, a message indicating a release of one or more resources associated with the released slice.

In some examples, the request processing component 1015 is configured to receive, from the first LAN client, a second request to delete a second network slice, where the second request is based on the multicast message. In some examples, the request processing component 1015 is configured to receive, from the first LAN client, a second request to initialize an application using a first wireless area network. In some examples, the request processing component 1015 is configured to receive, from the first LAN client, a request to initialize an application at the first LAN client using a first wireless area network, where receiving the identifier is based on receiving the request.

In some examples, the request processing component 1015 is configured to receive, from the first LAN client, a request associated with the available network slice. In some examples, receiving the identifier associated with the available network slice is based on receiving the request. In some examples, the request processing component 1015 is configured to determine, in response to receiving the request, that the request is associated with the available network slice, where establishing the connection associated with the available network slice is based on determining that the request is associated with the available network slice.

In some examples, the request processing component 1015 is configured to transmit, to a network device based on receiving the identifier, a request to access the available network slice. In some examples, the request processing component 1015 is configured to receive, from the first LAN client, a request to initialize an application using a first wireless area network.

In some examples, the request processing component 1015 is configured to transmit, to a network device, the request to initialize the application of the first LAN client using the first wireless area network. In some examples, the connection establishment component 1020 is configured to establish, at the device based on a successful validation of the identifier, a connection associated with the available network slice.

In some examples, the connection establishment component 1020 is configured to establish, at the device based on receiving the confirmation to access the new network slice, a second connection associated with the new network slice. In some examples, the confirmation component 1025 is configured to transmit, to the first LAN client based on establishing the connection, a confirmation to access the available network slice.

In some examples, the confirmation component 1025 is configured to transmit, to the first LAN client based on establishing the second connection, the confirmation to access the new network slice. In some examples, the confirmation component 1025 is configured to transmit, to the first LAN client, a confirmation to terminate the new communication session associated with the available network slice.

In some examples, the confirmation component 1025 is configured to receive, from the network device, a confirmation to access the available network slice, where establishing the connection associated with the available network slice is based on receiving the confirmation from the network device, and where the confirmation transmitted to the first LAN client is based on the confirmation received from the network device. In some examples, the confirmation component 1025 is configured to transmit, to the first LAN client, a confirmation to terminate the new communication session associated with the available network slice.

The identifier component 1055 is configured to receive, from a first LAN client of the one or more LAN clients based on the multicast message, an identifier associated with the available network slice. In some examples, the identifier component 1055 may determine, in response to receiving the request, whether the identifier associated with the available network slice matches a second identifier, where establishing the connection associated with the available network slice is based on determining that the identifier associated with the available network slice matches the second identifier.

In some examples, receiving, from the first LAN client, an indication of a released slice based on transmitting the confirmation to terminate the new communication session, where the released slice includes the available network slice. In some examples, receiving, from the first LAN client, an indication of a released slice based on transmitting the confirmation to terminate the new communication session, where the released slice includes the available network slice.

In some examples, the QoS component 1035 is configured to determine a QoS parameter associated with the available network slice based on initiating the new communication session. In some examples, the QoS component 1035 is configured to update the QoS parameter associated with the available network slice based on receiving the indication of the released slice.

In some examples, the QoS component 1035 is configured to determine whether the one or more data packets satisfy a QoS threshold, where establishing the connection associated with the available network slice is based on determining that the one or more data packets satisfy the QoS threshold. In some examples, the QoS component 1035 is configured to determine a QoS parameter associated with the available network slice based on initiating the new communication session. In some examples, the QoS component 1035 is configured to update the QoS parameter associated with the available network slice based on receiving the indication of the released slice.

The information component 1045 is configured to receive, from the network device, information associated with a set of network slices based on transmitting the second request. In some implementations, the information includes one or more of network slice selection assistance information, configured slice selection assistance information, or allowed slice selection assistance information. The communication session component 1050 is configured to initiate, in response to transmitting the confirmation to access the available network slice, a new communication session with an application provider. In some examples, the communication session component 1050 is configured to receive, from the first LAN client, an indication of a termination of the new communication session associated with the available network slice.

In some examples, the communication session component 1050 is configured to initiate, in response to transmitting the confirmation to access the available network slice, a new communication session with an application provider. In some examples, the communication session component 1050 is configured to receive, from the first LAN client, an indication of a termination of the new communication session associated with the available network slice.

FIG. 11 shows a block diagram of an example wireless communication system that supports techniques for managing a WLAN connection based on a QoS for a network slice. A wireless communication device 1105 may be configured to perform one or more of the processes illustrated in timing diagrams 400 and 600, or any of the processes 1200 and 1300 described above with reference to FIGS. 4, 6, 12 and 13, respectively. In some implementations, the wireless communication device 1105 can be an example implementation of a 5G-CPE 150 described herein with reference to FIGS. 1B, 2, 4, 5 and 6 or a wireless communication device described herein with reference to FIG. 8 or a wireless communication device described herein with reference to FIG. 9. For example, the wireless communication device 1105 can be a chip, SoC, chipset, package or device that includes at least one processor, a Wi-Fi (IEEE 802.11) modem, and a cellular modem.

In some implementations, the wireless communication device 1105 can be a CPE or a device for use in a CPE (as such, the wireless communication device 1105 may hereinafter be referred to as CPE). In some implementations, the CPE can be, or can include, an AP (such as AP 102) for serving one or more WLANs such as using a Wi-Fi network or a 5G network.

The wireless communication device 1105 includes a communications manager 1110, network communications manager 1115, a transceiver 1120, one or more antennas 1125, memory 1130, a processor 1140, and an inter-station communications manager 1145. Portions of one or more of the modules 1110, 1115, 1120, 1125, 1130, 1014, 1140, and 1145 may be implemented at least in part in hardware or firmware. For example, the communications manager 1110 at least in part by a modem. In some implementations, at least some of the modules 1110, 1115, 1120, 1125, 1130, 1014, 1140, and 1145 are implemented at least in part as software stored in a memory. For example, portions of one or more of the modules 1110, 1115, 1120, 1125, 1130, 1014, 1140, and 1145 can be implemented as non-transitory instructions (or “code”) executable by a processor to perform the functions or operations of the respective module.

The communications manager 1110 is configured to transmit, to one or more LAN clients (such as UEs or STAs) of the device, a multicast message indicating an available network slice and receive, from a first LAN client of the one or more LAN clients based on the multicast message, a request to access the available network slice. The communications manager 1110 is configured to establish, at the device based on receiving the request, a connection associated with the available network slice, and transmit, to the first LAN client based on establishing the connection, a confirmation to access the available network slice. The communications manager 1110 is further configured to transmit, to one or more LAN clients of the device, a multicast message indicating an available network slice.

The communications manager 1110 is configured to receive, from a first LAN client of the one or more LAN clients based on the multicast message, an identifier associated with the available network slice, and establish, at the device based on a successful validation of the identifier, a connection associated with the available network slice The communications manager 1110 is configured to transmit, to the first LAN client based on establishing the connection, a confirmation to access the available network slice.

The network communications manager 1115 is configured to manage communications with the core network (for example, via one or more wired backhaul links). For example, the network communications manager 1115 is configured to manage the transfer of data communications for client devices, such as one or more UEs 115.

The transceiver 1120 is configured to communicate bi-directionally, via one or more antennas, wired, or wireless links as described above. For example, the transceiver 1120 is configured to represent a wireless transceiver and may communicate bi-directionally with another wireless transceiver. The transceiver 1120 also may include a modem to modulate the packets and provide the modulated packets to the antennas for transmission, and to demodulate packets received from the antennas.

In some implementations, the wireless device may include a single antenna 1125. However, in some implementations, the device may have more than one antenna 1125, which may be capable of concurrently transmitting or receiving multiple wireless transmissions.

The memory 1130 may include RAM and ROM. The memory 1130 may store computer-readable, computer-executable code 1135 including instructions that, when executed, cause the processor to perform various functions described herein. In some implementations, the memory 1130 may contain, among other things, a basic input/output system (BIOS) which may control basic hardware or software operation such as the interaction with peripheral components or devices.

The processor 1140 may include an intelligent hardware device, (for example, general-purpose processor, a digital signal processor (DSP), a CPU, a microcontroller, an application specific integrated circuit (ASIC), a field-programmable gate array (FPGA), a programmable logic device, a discrete gate or transistor logic component, a discrete hardware component, or any combination thereof). In some implementations, the processor 1140 may be configured to operate a memory array using a memory controller. In other implementations, a memory controller may be integrated into processor 1140. The processor 1140 may be configured to execute computer-readable instructions stored in a memory to perform various functions (for example, functions or tasks supporting participation of LAN clients in a network slice).

The inter-station communications manager 1145 is configured to manage communications with other wireless communication devices (for example, the APs 102 or the STAs 104), and may include a controller or scheduler for controlling communications. For example, the inter-station communications manager 1145 may coordinate scheduling for transmissions for various interference mitigation techniques such as beamforming or joint transmission.

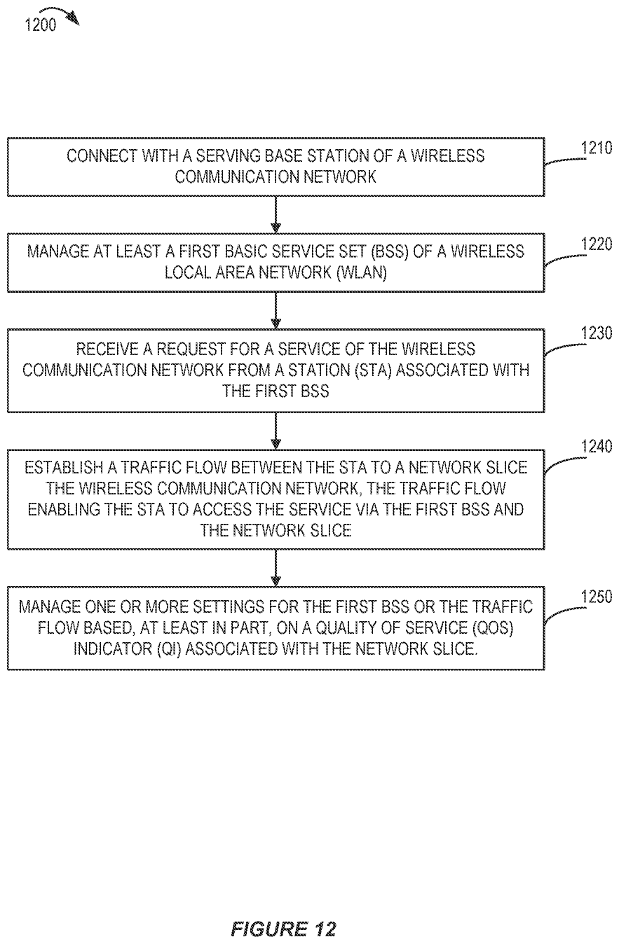

FIG. 12 shows a flowchart illustrating an example process 1200 performed by an 5G-CPE for enabling access to a service of a wireless communication system. In some implementations, the process 1200 may be performed by an AP or a CPE such as any of those described herein, including the AP 102 or the 5G-CPE 150, described with reference to FIGS. 1A, 1B, 2, 4, 5 and 6, respectively. In some implementations, the process 1200 may be performed by a wireless communication device such any of the devices described with reference to FIGS. 8, 9, 10, 11 and 15. For brevity, the example process 1200 is described as being performed by an apparatus that could be any of the above indicated UEs, wireless communication devices, or a component thereof.

In block 1210, the apparatus may connect with a serving base station of a wireless communication network. In block 1220, the apparatus may manage at least a first basic service set (BSS) of a wireless local area network (WLAN). In block 1230, the apparatus may receive a request for a service of the wireless communication network from a station (STA) associated with the first BSS. In block 1240, the apparatus may establish a traffic flow between the STA to a network slice the wireless communication network, the traffic flow enabling the STA to access the service via the first BSS and the network slice. In block 1250, the apparatus may manage one or more settings for the first BSS or the traffic flow based, at least in part, on a quality of service (QoS) Indicator (QI) associated with the network slice.

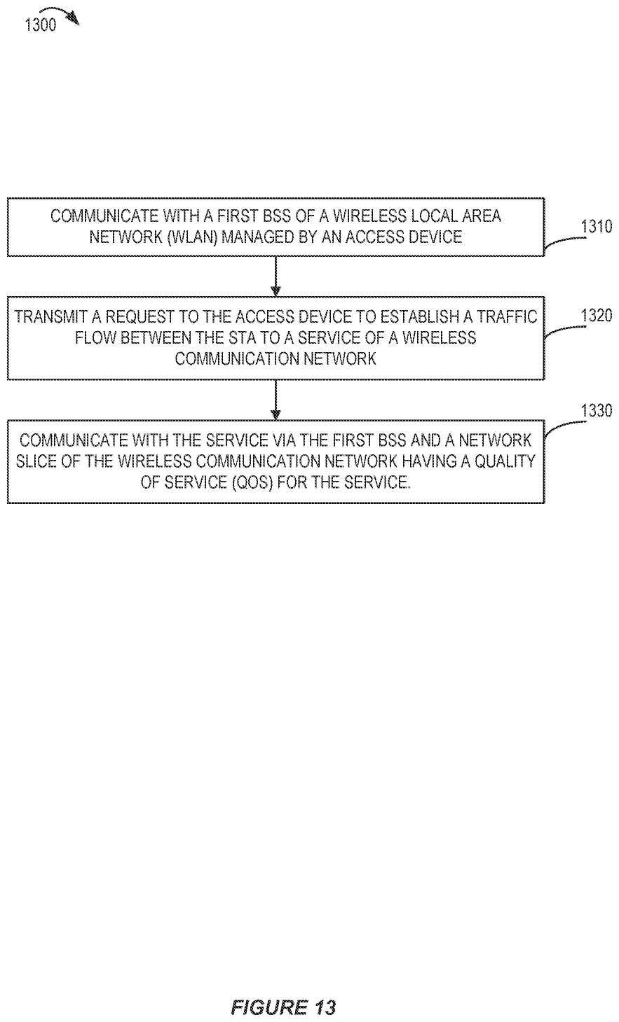

FIG. 13 shows a flowchart illustrating an example process performed by a STA for utilizing a service of a wireless communication system. In some implementations, the process 1300 may be performed by a STA or UE such as any of those described herein, including the STAs 104 the UEs 120, 124, or 360 described with reference to FIGS. 1A, 1B, 2, 3, 4 and 5, respectively. In some implementations, the process 1300 may be performed by a wireless communication device such any of the devices described with reference to FIGS. 8, 9, 10, 11 and 15. For brevity, the example process 1300 is described as being performed by an apparatus that could be any of the above indicated UEs, wireless communication devices, or a component thereof.

In block 1310, the apparatus may communicate with a first BSS of a wireless local area network (WLAN) managed by an 5G-CPE. In block 1320, the apparatus may transmit a request to the 5G-CPE to establish a traffic flow between the STA to a service of a wireless communication network. In block 1330, the apparatus may communicate with the service via the first BSS and a network slice of the wireless communication network having a quality of service (QoS) for the service.

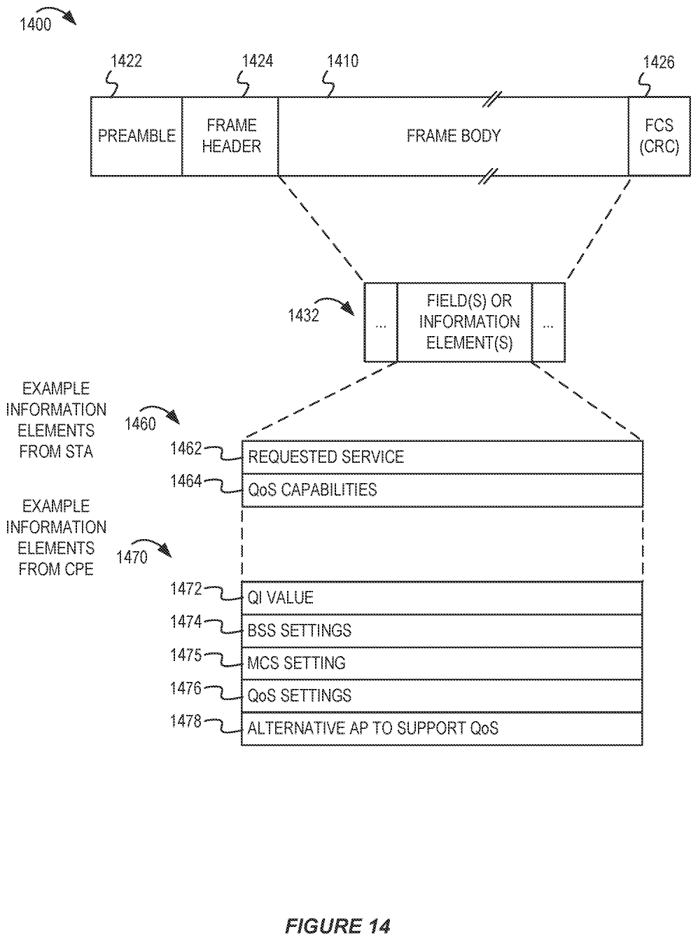

FIG. 14 shows a conceptual diagram of an example message format 1400 for communicating regarding a service request and associated QoS parameters. For example, the message format 1400 may describe one or more example messages transmitted between a STA/UE and an AP/CPE. In some implementations, the message format 1400 may be transmitted as a PPDU configured for HE- or EHT-capable devices. The message format 1400 (which also may be formatted as a PPDU) may include a preamble 1422, a frame header 1424, a frame body 1410, and a frame check sequence (FCS) 1426. The preamble 1422 may include one or more bits to establish synchronization. The frame header 1424 may include source and destination network addresses (such as the network address of the sending AP and receiving AP, respectively), the length of the data frame, or other frame control information. The frame body 1410 may include a variety of fields or information elements 1432. This disclosure includes a non-exhaustive list of example information elements 1460 and 1470 that may be transmitted by a STA or an AP, respectively.

Example information elements 1460 that a STA (such as the STA 104) may transmit include an indication of a requested service 1462 and QoS capabilities 1464 of the STA. For example, the indication of the requested service 1462 may include an S-NSSAI, an SST, an SD, among other examples. The QoS capabilities 1464 may indicate which QoS related enhancements are supported by the STA, such as the use of MIMO, MU-EDCA, among other examples.

Example information elements 1470 that an AP or 5G-CPE may transmit include a QI value 1472 associated with the network slice created to access the requested service. The example information elements 1470 may include one or more BSS settings 1474 to manipulate behavior of one or more STAs in the BSS to give priority to those devices utilizing a URLLC service. The example information elements 1470 may include an MCS setting 1475, one or more QoS settings 1476, or other parameters to adjust the reliability or latency for traffic to or from a STA utilizing the URLLC service. The example information elements 1470 may include an identification of an alternative AP 1478 capable of supporting the QoS needed for the URLLC service. For example, the identification may indicate an SSID of an AP operating in the 6 GHz frequency band.

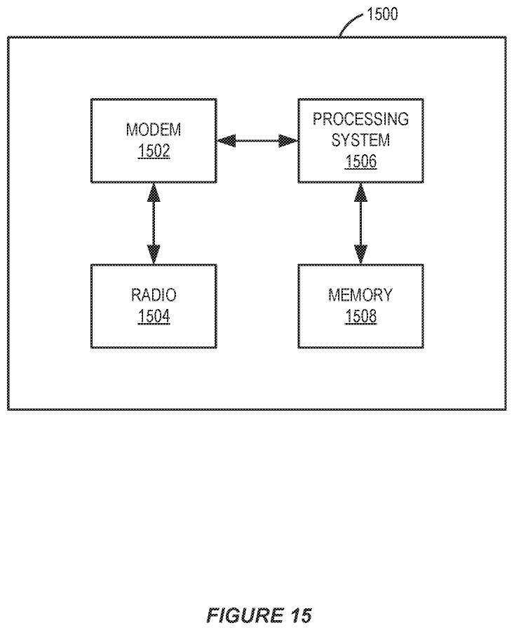

FIG. 15 shows a block diagram of an example wireless communication device. In some implementations, the wireless communication device 1500 can be an example of a device for use in a UE, such as the UE 120 described herein. The wireless communication device 1500 is capable of transmitting (or outputting for transmission) and receiving wireless communications.

The wireless communication device 1500 can be, or can include, a chip, system on chip (SoC), chipset, package or device. The term “system-on-chip” (SoC) is used herein to refer to a set of interconnected electronic circuits typically, but not exclusively, including one or more processors, a memory, and a communication interface. The SoC may include a variety of different types of processors and processor cores, such as a general purpose processor, a central processing unit (CPU), a digital signal processor (DSP), a graphics processing unit (GPU), an accelerated processing unit (APU), a sub-system processor, an auxiliary processor, a single-core processor, and a multicore processor. The SoC may further include other hardware and hardware combinations, such as a field programmable gate array (FPGA), a configuration and status register (CSR), an application-specific integrated circuit (ASIC), other programmable logic device, discrete gate logic, transistor logic, registers, performance monitoring hardware, watchdog hardware, counters, and time references. SoCs may be integrated circuits (ICs) configured such that the components of the IC reside on the same substrate, such as a single piece of semiconductor material (such as, for example, silicon).

The term “system in a package” (SIP) is used herein to refer to a single module or package that may contain multiple resources, computational units, cores or processors on two or more IC chips, substrates, or SoCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP also may include multiple independent SoCs coupled together via high speed communication circuitry and packaged in close proximity, such as on a single motherboard or in a single mobile communication device. The proximity of the SoCs facilitates high speed communications and the sharing of memory and resources.

The term “multicore processor” is used herein to refer to a single IC chip or chip package that contains two or more independent processing cores (for example a CPU core, IP core, GPU core, among other examples) configured to read and execute program instructions. An SoC may include multiple multicore processors, and each processor in an SoC may be referred to as a core. The term “multiprocessor” may be used herein to refer to a system or device that includes two or more processing units configured to read and execute program instructions.

The wireless communication device 1500 may include one or more modems 1502. In some implementations, the one or more modems 1502 (collectively “the modem 1502”) may include a WWAN modem (for example, a 3GPP 4G LTE or 5G compliant modem). In some implementations, the wireless communication device 1500 also includes one or more radios (collectively “the radio 1504”). In some implementations, the wireless communication device 1500 further includes one or more processors, processing blocks or processing elements (collectively “the processing system 1506”) and one or more memory blocks or elements (collectively “the memory 1508”). In some implementations, the processing system 1506 can include the memory 1508.

The modem 1502 can include an intelligent hardware block or device such as, for example, an application-specific integrated circuit (ASIC) among other possibilities. The modem 1502 is generally configured to implement a PHY layer. For example, the modem 1502 is configured to modulate packets and to output the modulated packets to the radio 1504 for transmission over the wireless medium. The modem 1502 is similarly configured to obtain modulated packets received by the radio 1504 and to demodulate the packets to provide demodulated packets. In addition to a modulator and a demodulator, the modem 1502 may further include digital signal processing (DSP) circuitry, automatic gain control (AGC), a coder, a decoder, a multiplexer and a demultiplexer. For example, while in a transmission mode, data obtained from the processing system 1506 is provided to a coder, which encodes the data to provide encoded bits. The encoded bits are mapped to points in a modulation constellation (using a selected MCS) to provide modulated symbols. The modulated symbols may be mapped to a number NSS of spatial streams or a number NSTS of space-time streams. The modulated symbols in the respective spatial or space-time streams may be multiplexed, transformed via an inverse fast Fourier transform (IFFT) block, and subsequently provided to the DSP circuitry for Tx windowing and filtering. The digital signals may be provided to a digital-to-analog converter (DAC). The resultant analog signals may be provided to a frequency upconverter, and ultimately, the radio 1504. In implementations involving beamforming, the modulated symbols in the respective spatial streams are precoded via a steering matrix prior to their provision to the IFFT block.

While in a reception mode, digital signals received from the radio 1504 are provided to the DSP circuitry, which is configured to acquire a received signal, for example, by detecting the presence of the signal and estimating the initial timing and frequency offsets. The DSP circuitry is further configured to digitally condition the digital signals, for example, using channel (narrowband) filtering, analog impairment conditioning (such as correcting for I/Q imbalance), and applying digital gain to ultimately obtain a narrowband signal. The output of the DSP circuitry may be fed to the AGC, which is configured to use information extracted from the digital signals, for example, in one or more received training fields, to determine an appropriate gain. The output of the DSP circuitry also is coupled with the demodulator, which is configured to extract modulated symbols from the signal and, for example, compute the logarithm likelihood ratios (LLRs) for each bit position of each subcarrier in each spatial stream. The demodulator is coupled with the decoder, which may be configured to process the LLRs to provide decoded bits. The decoded bits from all of the spatial streams are fed to the demultiplexer for demultiplexing. The demultiplexed bits may be descrambled and provided to the MAC layer (the processing system 1506) for processing, evaluation, or interpretation.

The radio 1504 generally includes at least one radio frequency (RF) transmitter (or “transmitter chain”) and at least one RF receiver (or “receiver chain”), which may be combined into one or more transceivers. For example, the RF transmitters and receivers may include various DSP circuitry including at least one power amplifier (PA) and at least one low-noise amplifier (LNA), respectively. The RF transmitters and receivers may, in turn, be coupled to one or more antennas. For example, in some implementations, the wireless communication device 1500 can include, or be coupled with, multiple transmit antennas (each with a corresponding transmit chain) and multiple receive antennas (each with a corresponding receive chain). The symbols output from the modem 1502 are provided to the radio 1504, which transmits the symbols via the coupled antennas. Similarly, symbols received via the antennas are obtained by the radio 1504, which provides the symbols to the modem 1502.

The processing system 1506 can include an intelligent hardware block or device such as, for example, a processing core, a processing block, a central processing unit (CPU), a microprocessor, a microcontroller, a digital signal processor (DSP), an application-specific integrated circuit (ASIC), a programmable logic device (PLD) such as a field programmable gate array (FPGA), discrete gate or transistor logic, discrete hardware components, or any combination thereof designed to perform the functions described herein. The processing system 1506 processes information received through the radio 1504 and the modem 1502, and processes information to be output through the modem 1502 and the radio 1504 for transmission through the wireless medium. In some implementations, the processing system 1506 may generally control the modem 1502 to cause the modem to perform various operations described above.

The memory 1508 can include tangible storage media such as random-access memory (RAM) or read-only memory (ROM), or combinations thereof. The memory 1508 also can store non-transitory processor- or computer-executable software (SW) code containing instructions that, when executed by the processing system 1506, cause the processor to perform various operations described herein for wireless communication, including the generation, transmission, reception and interpretation of MPDUs, frames or packets. For example, various functions of components disclosed herein, or various blocks or steps of a method, operation, process or algorithm disclosed herein, can be implemented as one or more modules of one or more computer programs.

FIGS. 1-15 and the operations described herein are examples meant to aid in understanding example implementations and should not be used to limit the potential implementations or limit the scope of the claims. Some implementations may perform additional operations, fewer operations, operations in parallel or in a different order, and some operations differently.

The foregoing disclosure provides illustration and description but is not intended to be exhaustive or to limit the aspects to the precise form disclosed. Modifications and variations may be made in light of the above disclosure or may be acquired from practice of the aspects. While the aspects of the disclosure have been described in terms of various examples, any combination of aspects from any of the examples is also within the scope of the disclosure. The examples in this disclosure are provided for pedagogical purposes. Alternatively, or in addition to the other examples described herein, examples include any combination of the following implementation options (identified as clauses for reference).

### Clauses

Clause 1. A method for wireless communication by an access device, including: connecting with a serving base station (BS) of a wireless communication network; managing at least a first basic service set (BSS) of a wireless local area network (WLAN); receiving a request for a service of the wireless communication network from a station (STA) associated with the first BSS; establishing a traffic flow between the STA to a network slice of the wireless communication network, the traffic flow enabling the STA to access the service via the first BSS and the network slice; and managing one or more settings for the first BSS or the traffic flow based, at least in part, on a quality of service (QoS) Indicator (QI) associated with the network slice.

Clause 2. The method of clause 1, where the service is an Ultra-Reliable Low Latency Communication (URLLC) service, and where managing the one or more settings includes managing the first BSS to satisfy a guaranteed bit rate (GBR) associated with the URLLC service.

Clause 3. The method of any one of clauses 1-2, where establishing the traffic flow includes: establishing a first packet data network (PDN) bearer to the network slice that is dedicated to the STA; and mapping the first PDN bearer to a buffer of the access device to manage uplink and downlink traffic for the STA according to the QI.

Clause 4. The method of any one of clauses 1-3, further including: managing, by the access device, a second BSS of the WLAN, where the request for the service is received from the STA via the second BSS; determining that the second BSS cannot support the QI and that the first BSS does support the QI; and causing the STA to associate with the first BSS before establishing the traffic flow.

Clause 5. The method of clause 4, where the first BSS utilizes a 6 Gigahertz (6 GHz) wireless channel that supports contention and scheduling management capabilities to support the QI.

Clause 6. The method of any one of clauses 1-5, further including: determining whether the STA supports multiple-input-multiple-output (MIMO) communication using at least two spatial streams; establishing the traffic flow when the STA supports the MIMO communication using at least two spatial streams; and rejecting the request for the service when the STA does not support the MIMO communication using at least two spatial streams.

Clause 7. The method of any one of clauses 1-6, where the one or more settings includes a selected modulation and coding scheme (MCS) that is selected for uplink and downlink communication to the STA based, at least in part, on the QI associated with the service.

Clause 8. The method of clause 7, further including: selecting the MCS to provide a reliable transmission rate when the service is associated with URLLC.

Clause 9. The method of any one of clauses 1-8, further including: prioritizing traffic for the traffic flow in a highest traffic queue of the access device when the QI is associated with a guaranteed bit rate (GBR) or a delay critical GBR.

Clause 10. The method of any one of clauses 1-9, further including: enabling orthogonal frequency division multiple access (OFDMA) and beamforming when the QI is associated with a guaranteed bit rate (GBR) or a delay critical GBR.

Clause 11. The method of any one of clauses 1-10, further including: determining that the QI is associated with a delay critical GBR; configuring contention parameters for the access device to suppress single user (SU) communication in favor of a multi-user enhanced distributed controlled access (MU-EDCA) mode downlink or uplink communications between the access device and the STA; and managing scheduling of the first BSS to prioritize access for uplink communication from the STA associated with the traffic flow.

Clause 12. The method of clause 11, where managing the scheduling for uplink communication includes decreasing a qdepth buffer threshold associated with triggering the uplink communication from the STA.

Clause 13. The method of any one of clauses 11-12, where managing the scheduling for uplink communication includes: allocating resources of an uplink multi-user (UL-MU) trigger frame to support the delay critical GBR.

Clause 14. The method of any one of clauses 11-13, where managing the scheduling for uplink communication includes transmitting a sufficient quantity of trigger frames to the STA over a duration of time to satisfy the delay critical GBR.

Clause 15. The method of any one of clauses 11-14, where managing the scheduling for uplink communication includes transmitting a plurality of trigger frames using a periodicity to satisfy the delay critical GBR.

Clause 16. A method for wireless communication by a station (STA) of a wireless local area network, including: communicating with a first BSS of a wireless local area network (WLAN) managed by an access device; and transmitting a request to the access device to establish a traffic flow between the STA to a service of a wireless communication network; and communicating with the service via the first BSS and a network slice of the wireless communication network having a quality of service (QoS) for the service.

Clause 17. The method of clause 16, where the STA utilizes a QoS provided by the first BSS that is based, at least in part, on a QoS Indicator (QI) associated with the network slice.

Clause 18. The method of any one of clauses 16-17, further including: transmitting the request via a second BSS managed by the access device; and receiving a redirection message from the access device that instructs the STA to transmit the request via the first BSS.

Clause 19. The method of any one of clauses 16-18, where the first BSS utilizes a wireless channel in a 6 GHz frequency band.

Clause 20. The method of any one of clauses 16-19, where communicating with the service via the first BSS includes enabling a multi-input-multiple-output (MIMO) configuration having at least 2 spatial streams.

Clause 21. The method of any one of clauses 16-20, where communicating with the service via the first BSS includes disabling a single user (SU) access mode and enabling a multi-user (MU) access mode.

Clause 22. An apparatus of an access device, including: at least one interface configured to: connect with a serving base station (BS) of a wireless communication network; manage at least a first basic service set (BSS) of a wireless local area network (WLAN), and obtain a request for a service of the wireless communication network from a station (STA) associated with the first BSS; and a processing system configured to: establish a traffic flow between the STA to a network slice the wireless communication network, the traffic flow enabling the STA to access the service via the first BSS and the network slice, and manage one or more settings for the first BSS or the traffic flow based, at least in part, on a quality of service (QoS) Indicator (QI) associated with the network slice.

Clause 23. The apparatus of clause 22, where the service is an Ultra-Reliable Low Latency Communication (URLLC) service, and where the processing system is configured to manage the first BSS to satisfy a guaranteed bit rate (GBR) associated with the URLLC service.

Clause 24. The apparatus of any one of clauses 22-23, where the processing system is configured to: establish a first packet data network (PDN) bearer to the network slice that is dedicated to the STA; and map the first PDN bearer to a buffer of the access device to manage uplink and downlink traffic for the STA according to the QI.

Clause 25. The apparatus of any one of clauses 22-24, where at least one interface configured to manage a second BSS of the WLAN, where the request for the service is received from the STA via the second BSS; and where the processing system is configured to: determine that the second BSS cannot support the QI and that the first BSS does support the QI; and cause the STA to associate with the first BSS before establishing the traffic flow.

Clause 26. The apparatus of clause 25, where the first BSS utilizes a 6 Gigahertz (6 GHz) wireless channel that supports contention and scheduling management capabilities to support a QoS associated with the QI.

Clause 27. The apparatus of any one of clauses 22-26, where the processing system is configured to: determine whether the STA supports multiple-input-multiple-output (MIMO) communication using at least two spatial streams; establish the traffic flow when the STA supports the MIMO communication using at least two spatial streams; and reject the request for the service when the STA does not support the MIMO communication using at least two spatial streams.

Clause 28. The apparatus of any one of clauses 22-27, where the one or more settings includes a selected modulation and coding scheme (MCS) that is selected for uplink and downlink communication to the STA based, at least in part, on the QI associated with the service.

Clause 29. The apparatus of clause 28, where the processing system is configured to select the MCS to provide a reliable transmission rate when the service is associated with URLL C.

Clause 30. The apparatus of any one of clauses 22-29, where the processing system is configured to: prioritize traffic for the traffic flow in a highest traffic queue of the access device when the QI is associated with a guaranteed bit rate (GBR) or a delay critical GBR.

Clause 31. The apparatus of any one of clauses 22-30, where the processing system is configured to: enable orthogonal frequency division multiple access (OFDMA) and beamforming when the QI is associated with a guaranteed bit rate (GBR) or a delay critical GBR.

Clause 32. The apparatus of any one of clauses 22-31, where the processing system is configured to: determine that the QI is associated with a delay critical GBR; configure contention parameters for the access device to suppress single user (SU) communication in favor of a multi-user enhanced distributed controlled access (MU-EDCA) mode downlink or uplink communications between the access device and the STA; and manage scheduling of the first BSS to prioritize access for uplink communication from the STA associated with the traffic flow.

Clause 33. The apparatus of clause 32, where the processing system is configured to decrease a qdepth buffer threshold associated with triggering the uplink communication from the STA.

Clause 34. The apparatus of any one of clauses 32-33, where the processing system is configured to: allocate resources of an uplink multi-user (UL-MU) trigger frame to support the delay critical GBR.

Clause 35. The apparatus of any one of clauses 32-34, where the processing system is configured to cause the at least one interface to transmit a sufficient quantity of trigger frames to the STA over a duration of time to satisfy the delay critical GBR.

Clause 36. The apparatus of any one of clauses 32-35, where the processing system is configured to cause the at least one interface to transmit the plurality of trigger frames using a periodicity to satisfy the delay critical GBR.

Clause 37. The apparatus of any one of clauses 22-36, further including: at least one transceiver coupled to the at least one interface; at least one antenna coupled to the at least one transceiver to wirelessly transmit signals output from the at least one transceiver and to wirelessly receive signals for input into the at least one transceiver; and a housing that encompasses the at least one interface, the at least one transceiver and at least a portion of the at least one antenna.

Clause 38. An apparatus of a user equipment (UE), including: at least one station (STA) interface configured to: communicate with a first BSS of a wireless local area network (WLAN) managed by an access device; and output a request for transmission to the access device to establish a traffic flow between the STA to a service of a wireless communication network; and communicate with the service via the first BSS and a network slice of the wireless communication network having a quality of service (QoS) for the service.

Clause 39. The apparatus of clause 38, where the at least one STA interface utilizes a QoS provided by the first BSS that is based, at least in part, on a QoS Indicator (QI) associated with the network slice.

Clause 40. The apparatus of any one of clauses 38-39, further including: the at least one STA interface further configured to: transmit the request via a second BSS managed by the access device; and receive a redirection message from the access device that instructs the at least one STA interface to output the request for transmission via the first BSS.

Clause 41. The apparatus of any one of clauses 38-50, where the first BSS utilizes a wireless channel in a 6 GHz frequency band.

Clause 42. The apparatus of any one of clauses 38-41, where at least one STA interface is configured to communicate with the service via the first BSS by enabling a multi-input-multiple-output (MIMO) configuration having at least 2 spatial streams.

Clause 43. The apparatus of any one of clauses 38-42, where at least one STA interface is configured to communicate with the service via the first BSS by disabling a single user (SU) access mode and enabling a multi-user (MU) access mode.

Clause 44. The apparatus of any one of clauses 38-43, further including: at least one transceiver coupled to the at least one STA interface; at least one antenna coupled to the at least one transceiver to wirelessly transmit signals output from the at least one transceiver and to wirelessly receive signals for input into the at least one transceiver; and a housing that encompasses the at least one STA interface, the at least one transceiver and at least a portion of the at least one antenna.

Another innovative aspect of the subject matter described in this disclosure can be implemented in a wireless communication device. In some implementations, the wireless communication device includes at least one interface and at least one processor configured to perform any one of the above referenced methods.

Another innovative aspect of the subject matter described in this disclosure can be implemented in the wireless communication device having at least one memory communicatively coupled with the at least one processor and storing processor-readable code that, when executed by the at least one processor, causes the wireless communication device to implement any one of the above referenced methods.

Another innovative aspect of the subject matter described in this disclosure can be implemented a mobile station including the wireless communication device and one or more transceivers coupled to the wireless communication device to communicate with a WLAN. The mobile station may include one or more antennas coupled to the one or more transceivers to wirelessly transmit signals output from the transceivers and to wirelessly receive signals for input into the transceivers. The mobile station may include a housing that encompasses the wireless communication device, the one or more transceivers and at least a portion of the one or more antennas.

Another innovative aspect of the subject matter described in this disclosure can be implemented in an apparatus having at least one processor and at least one memory communicatively coupled with the at least one processor of a wireless communication device and storing processor-readable code that, when executed by the at least one processor, causes the wireless communication device to implement any one of the above referenced methods.

Another innovative aspect of the subject matter described in this disclosure can be implemented in a tangible computer-readable storage medium including non-transitory processor-executable code which, when executed by at least one processor of a wireless communication device, causes the wireless communication device to implement any one of the above referenced methods.

As used herein, the term “component” is intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.”

As used herein, a phrase referring to “at least one of” or “one or more of” a list of items refers to any combination of those items, including single members. For example, “at least one of: a, b, or c” is intended to cover the possibilities of: a only, b only, c only, a combination of a and b, a combination of a and c, a combination of b and c, and a combination of a and b and c.

The various illustrative components, logic, logical blocks, modules, circuits, operations and algorithm processes described in connection with the implementations disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

The hardware and data processing apparatus used to implement the various illustrative components, logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, multiple microprocessors, one or more microprocessors in conjunction with a DSP core, or any other such configuration. In some implementations, particular processes, operations and methods may be performed by circuitry that is specific to a given function.

As described above, in some aspects implementations of the subject matter described in this specification can be implemented as software. For example, various functions of components disclosed herein or various blocks or steps of a method, operation, process or algorithm disclosed herein can be implemented as one or more modules of one or more computer programs. Such computer programs can include non-transitory processor- or computer-executable instructions encoded on one or more tangible processor- or computer-readable storage media for execution by, or to control the operation of, data processing apparatus including the components of the devices described herein. By way of example, and not limitation, such storage media may include RAM, ROM, EEPROM, CD-ROM or other optical disk storage, magnetic disk storage or other magnetic storage devices, or any other medium that may be used to store program code in the form of instructions or data structures. Combinations of the above should also be included within the scope of storage media.

Various modifications to the implementations described in this disclosure may be readily apparent to persons having ordinary skill in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, various features that are described in this specification in the context of separate implementations also can be implemented in combination in a single implementation. Conversely, various features that are described in the context of a single implementation also can be implemented in multiple implementations separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

What is claimed is:

1. A method for wireless communication by an access device, comprising:
connecting with a serving base station (BS) of a wireless communication network;
managing at least a first basic service set (BSS) of a wireless local area network (WLAN);
receiving a request for a service of the wireless communication network from a station (STA) associated with the first BSS;
establishing a traffic flow between the STA to a network slice of the wireless communication network, the traffic flow enabling the STA to access the service via the first BSS and the network slice; and
managing one or more settings for the first BSS, the traffic flow, or both the first BSS and the traffic flow based, at least in part, on a quality of service (QoS) Indicator (QI) associated with the network slice.

2. The method of claim 1, wherein the service is an Ultra-Reliable Low Latency Communication (URLLC) service, and wherein managing the one or more settings includes managing the first BSS to satisfy a guaranteed bit rate (GBR) associated with the URLLC service.

3. The method of claim 1, wherein establishing the traffic flow includes:
establishing a first packet data network (PDN) bearer to the network slice that is dedicated to the STA; and
mapping the first PDN bearer to a buffer of the access device to manage uplink and downlink traffic for the STA according to the QI.

4. The method of claim 1, further comprising:
managing, by the access device, a second BSS of the WLAN, wherein the request for the service is received from the STA via the second BSS;
determining that the second BSS cannot support the QI and that the first BSS does support the QI; and
causing the STA to associate with the first BSS before establishing the traffic flow.

5. The method of claim 4, wherein the first BSS utilizes a 6 Gigahertz (6 GHz) wireless channel that supports contention and scheduling management capabilities to support the QI.

6. The method of claim 1, further comprising:
determining whether the STA supports multiple-input-multiple-output (MIMO) communication using at least two spatial streams;
establishing the traffic flow when the STA supports the MIMO communication using at least two spatial streams; and
rejecting the request for the service when the STA does not support the MIMO communication using at least two spatial streams.

7. The method of claim 1, wherein the one or more settings includes a selected modulation and coding scheme (MCS) that is selected for uplink and downlink communication to the STA, the method further comprising:
selecting the MCS based, at least in part, on the QI associated with the service.

8. The method of claim 1, further comprising:
prioritizing traffic for the traffic flow in a highest traffic queue of the access device when the QI is associated with a guaranteed bit rate (GBR) or a delay critical GBR.

9. The method of claim 1, further comprising:
enabling orthogonal frequency division multiple access (OFDMA) and beamforming when the QI is associated with a guaranteed bit rate (GBR) or a delay critical GBR.

10. The method of claim 1, further comprising:
determining that the QI is associated with a delay critical GBR;
configuring contention parameters for the access device to suppress single user (SU) communication in favor of a multi-user enhanced distributed controlled access (MU-EDCA) mode downlink or uplink communications between the access device and the STA; and
managing scheduling of the first BSS to prioritize access for uplink communication from the STA associated with the traffic flow.

11. The method of claim 10, wherein managing the scheduling for uplink communication includes at least one member selected from a group consisting of:
decreasing a qdepth buffer threshold associated with triggering the uplink communication from the STA;
allocating resources of an uplink multi-user (UL-MU) trigger frame to support the delay critical GBR;
transmitting a sufficient quantity of trigger frames to the STA over a duration of time to satisfy the delay critical GBR; and
transmitting a plurality of trigger frames using a periodicity to satisfy the delay critical GBR.

12. A method for wireless communication by a station (STA) of a wireless local area network, comprising:
communicating with a first BSS of a wireless local area network (WLAN) managed by an access device; and
transmitting a request to the access device to establish a traffic flow between the STA to a service of a wireless communication network; and
communicating with the service via the first BSS and a network slice of the wireless communication network having a quality of service (QoS) for the service.

13. The method of claim 12, wherein the STA utilizes a QoS provided by the first BSS that is based, at least in part, on a QoS Indicator (QI) associated with the network slice.

14. The method of claim 12, further comprising:
transmitting the request via a second BSS managed by the access device; and
receiving a redirection message from the access device that instructs the STA to transmit the request via the first BSS.

15. The method of claim 12, wherein communicating with the service via the first BSS includes disabling a single user (SU) access mode and enabling a multi-user (MU) access mode.

16. An apparatus of an access device, comprising:
at least one interface configured to:
connect with a serving base station (BS) of a wireless communication network;
manage at least a first basic service set (BSS) of a wireless local area network (WLAN), and
obtain a request for a service of the wireless communication network from a station (STA) associated with the first BSS; and
a processing system configured to:
establish a traffic flow between the STA to a network slice the wireless communication network, the traffic flow enabling the STA to access the service via the first BSS and the network slice, and
manage one or more settings for the first BSS, the traffic flow, or both the first BSS and the traffic flow based, at least in part, on a quality of service (QoS) Indicator (QI) associated with the network slice.

17. The apparatus of claim 16, wherein the service is an Ultra-Reliable Low Latency Communication (URLLC) service, and wherein the processing system is configured to manage the first BSS to satisfy a guaranteed bit rate (GBR) associated with the URLLC service.

18. The apparatus of claim 16, wherein the processing system is configured to:
establish a first packet data network (PDN) bearer to the network slice that is dedicated to the STA; and
map the first PDN bearer to a buffer of the access device to manage uplink and downlink traffic for the STA according to the QI.

19. The apparatus of claim 16,
wherein at least one interface configured to manage a second BSS of the WLAN, wherein the request for the service is received from the STA via the second BSS; and
wherein the processing system is configured to:
determine that the second BSS cannot support the QI and that the first BSS does support the QI; and
cause the STA to associate with the first BSS before establishing the traffic flow.

20. The apparatus of claim 16, wherein the one or more settings includes a selected modulation and coding scheme (MCS) that is selected for uplink and downlink communication to the STA, and wherein the processing system is configured to select the MCS based, at least in part, on the QI associated with the service.

21. The apparatus of claim 16, wherein the processing system is configured to:
prioritize traffic for the traffic flow in a highest traffic queue of the access device when the QI is associated with a guaranteed bit rate (GBR) or a delay critical GBR.

22. The apparatus of claim 16, wherein the processing system is configured to:
enable orthogonal frequency division multiple access (OFDMA) and beamforming when the QI is associated with a guaranteed bit rate (GBR) or a delay critical GBR.

23. The apparatus of claim 16, wherein the processing system is configured to:
determine that the QI is associated with a delay critical GBR;
configure contention parameters for the access device to suppress single user (SU) communication in favor of a multi-user enhanced distributed controlled access (MU-EDCA) mode downlink or uplink communications between the access device and the STA; and
manage scheduling of the first BSS to prioritize access for uplink communication from the STA associated with the traffic flow.

24. The apparatus of claim 23, wherein the processing system being configured to manage scheduling to prioritize access for the uplink communication includes the processing system configured to perform at least one operation selected from a group consisting of:
decreasing a qdepth buffer threshold associated with triggering the uplink communication from the STA;
allocating resources of an uplink multi-user (UL-MU) trigger frame to support the delay critical GBR;
causing the at least one interface to output a sufficient quantity of trigger frames to the STA over a duration of time to satisfy the delay critical GBR; and
causing the at least one interface to output a plurality of trigger frames using a periodicity to satisfy the delay critical GBR.

25. The apparatus of claim 16, further comprising:
at least one transceiver coupled to the at least one interface;
at least one antenna coupled to the at least one transceiver to wirelessly transmit signals output from the at least one transceiver and to wirelessly receive signals for input into the at least one transceiver; and
a housing that encompasses the at least one interface, the at least one transceiver and at least a portion of the at least one antenna.

26. An apparatus of a user equipment (UE), comprising:
at least one station (STA) interface configured to:
communicate with a first BSS of a wireless local area network (WLAN) managed by an access device; and
output a request for transmission to the access device to establish a traffic flow between the STA to a service of a wireless communication network; and
communicate with the service via the first BSS and a network slice of the wireless communication network having a quality of service (QoS) for the service.

27. The apparatus of claim 26, wherein the at least one STA interface utilizes a QoS provided by the first BSS that is based, at least in part, on a QoS Indicator (QI) associated with the network slice.

28. The apparatus of claim 26, further comprising:
the at least one STA interface further configured to:
transmit the request via a second BSS managed by the access device; and
receive a redirection message from the access device that instructs the at least one STA interface to output the request for transmission via the first BSS.

29. The apparatus of claim 26, wherein at least one STA interface is configured to communicate with the service via the first BSS by disabling a single user (SU) access mode and enabling a multi-user (MU) access mode.

30. The apparatus of claim 26, further comprising:
at least one transceiver coupled to the at least one STA interface;
at least one antenna coupled to the at least one transceiver to wirelessly transmit signals output from the at least one transceiver and to wirelessly receive signals for input into the at least one transceiver; and
a housing that encompasses the at least one STA interface, the at least one transceiver and at least a portion of the at least one antenna.
